(19) United States
(12) Patent Application Publication
(10) Pub. No.: US 2011/0092621 A1
(43) Pub. Date: Apr. 21, 2011

(54) DYES WITH POLYESTER SIDE CHAIN FOR POLYMER-COLORATION, THEIR PREPARATION AND THEIR USE

(75) Inventors: Gunter Görlitz, Bad Soden (DE); Carsten Harfmann, Frankfurt (DE)

(73) Assignee: DyStar Colours Deutschland GmbH, Frankfurt Am Main (DE)

(21) Appl. No.: 12/680,408

(22) PCT Filed: Sep. 19, 2008
(86) PCT No.: PCT/EP2008/062567

§ 371 Date: Jan. 3, 2011

(30) Foreign Application Priority Data
Sep. 28, 2007 (DE) 10 2007 046 751.8

(51) Int. Cl. C08K 5/3432; C09B 29/42; C09B 43/00

(52) U.S. Cl. 524/99; 534/770; 534/588

(57) ABSTRACT

The invention relates to a dye of formula (1)

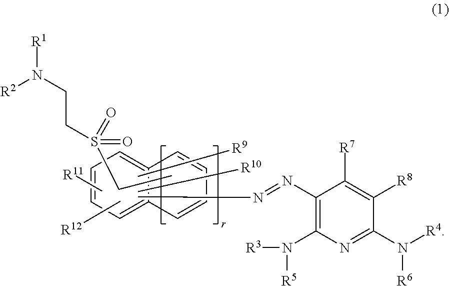

The also relates to the preparation of the dye and its uses.

Polymers can be colored with dyes in various ways. One way is mass coloration of polymers whereby for example a pigment or a dye is mixed with the polymer and the polymer is melted to transport the dye into the polymer matrix. Other processes involve the polymer being colored or, to be more precise, dyed by the dyes diffusing into the polymer from a solution or dispersion, examples being the dyeing of polymeric fibers composed of polyester, polyacrylonitrile, polyurethane, cellulose or polyamide for example with, for example, disperse dyes, cationic dyes, acid dyes, metallized dyes or reactive dyes, the use of reactive dyes resulting in a covalent bond being formed between the dye and the substrate, conferring particularly high fastnesses on the dyeings. Another way to color a polymer is to add a dye to the polymer's monomers or oligomers before the polymer is formed or as it is being formed. Dyes capable of forming covalent bonds with the polymer scaffold will here likewise result in colorations of high fastness. For this, the dyes used, or to be more precise, their chromophores have to be sufficiently stable under the conditions of the polymerization. These requirements vary with the type of polymerization. Polyurethanes are produced by essentially polymerizing diisocyanates with diols or polyols. Polyurethane foam is generated by adding water to the reaction mixture or using a blowing gas. Furthermore, stabilizers and activators such as for example amines, silicones and tin compounds are added to the reactants prior to the polymerization. The polymerization proceeds at elevated temperatures in the presence of highly reactive compounds and intermediates. To produce colored polyurethanes, the diol or polyol component may have added to it, before the polymerization, dyes which contain at least two hydroxyl groups, so that the dye can be covalently incorporated in the polymer chains during the polymerization without chain termination taking place as a result. The dye used must not affect the mechanical properties of the polyurethane. When the dye used is a solid material, it is advantageously dissolved in a solvent beforehand or used as a dye dispersion in a polyol for example. Dyes of this kind are known and are described in DE2259435 and DE2357933.

The solubility or dispersibility of the dye used can be significantly influenced through the choice of suitable substituents. The solubility or dispersibility can be improved through the choice of suitable side chains such that the use of solvent or dispersant matrix can be greatly reduced or even omitted entirely. Examples thereof are to be found in the documents WO2005000913, US2004250357 and US2004254335. Where polyurethane foams are produced, some dyes affect foam structure and hence foam mechanical properties, so that the colored foam has different mechanical properties than the uncolored foam, and that is undesirable. The actually available suitable dyes for producing colored polyurethane foam do not make it possible to cover every desired region in color space. There is therefore a need for dyes which have the specified properties and thus are useful for the coloration of polyurethane. WO 2007/039525 already discloses dyes which meet these requirements to a high degree.

It has now been found that dyes which contain oligoester substituents likewise constitute useful dyes for the coloration of polyurethane and other substrates. They have high stability under application conditions, are readily soluble or miscible with suitable organic solvents, and afford colorations having high fastnesses.

The present invention accordingly provides dyes of formula (1)

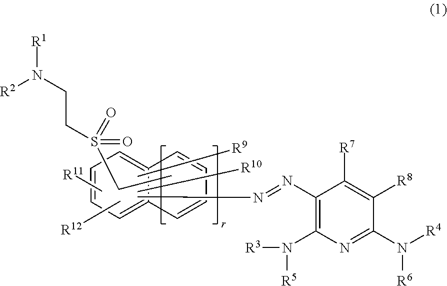

where
R¹ is aryl or (C₁-C₆₀)-alkyl which may each be substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —COOR¹⁴, —CONR¹⁶R¹⁶ or cyano and in the case of (C₁-C₆₀)-alkyl may be interrupted by arylene, —O—, —CO—, —COO—, —CONH—, —SO₂— or —NR¹³—;
R², R³, R⁴, R⁵ and R⁶ independently are hydrogen or have one of the meanings of R¹;
R⁷ is hydrogen or (C₁-C₄)-alkyl;
R⁸ is cyano, carbamoyl or sulfomethyl;
R⁹ to R¹² independently are hydrogen, have one of the meanings of R¹ or are hydroxyl, (C₁-C₄)-alkoxy, hydroxy-(C₁-C₄₀)alkyl, (C₂-C₄₀)-alkylene, halogen, —NHSO₂—, —COOR¹⁴, —CONR¹⁶R¹⁶ or cyano; or
any two of the R⁹ to R¹² radicals which are ortho to each other combine with the carbon atoms to which they are attached to form a 5- or 6-membered ring which may be substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —NHSO₂—, —COOR¹⁴, —CONR¹⁵R¹⁶ or cyano;
R¹³ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁴ is aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁵ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁶ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
r is 0 or 1; and
R¹ and at least one of the R² to R¹² radicals each contain at least one group of the formula (OE1)

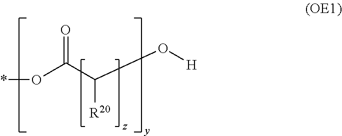

where
R²⁰ is hydrogen, aryl, (C₁-C₄)-alkoxy, hydroxy-(C₁-C₄)-alkyl, (C₁-C₁₀)-alkyl or (C₁-C₁₀)-alkyl interrupted by arylene, —O—, —CO—, —COO—, —CONH— or —SO₂—, where R²⁰, z and y may have different meanings within any one molecule;
z is an integer from 1 to 10; and
y is a number from 0.1 to 60.

In the group of formula (OE1), R²⁰, z and y may have different meanings within any one molecule; that is, R²⁰, z and y may be swapped in any desired manner, and thus be subjected to a random distribution, within any one idealized molecule of formula (1).

One group of formula (OE1) where R²⁰, z and y are subject to a random distribution conforms to formula (OE2)

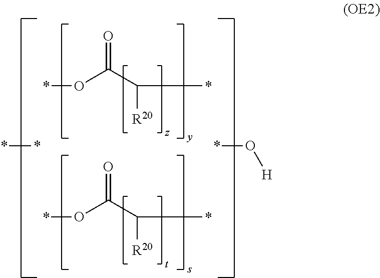

where R²⁰ is as defined above, R²¹ independently has one of the meanings of R²⁰, t has one of the meanings of z and s has one of the meanings of y.

The numbers y and s represent the statistical mean of the chain length of the ester groups (OE1) and (OE2) and thus may also represent fractional numbers.

In the abovementioned definitions, alkyl groups may be straight chain or branched and are for example methyl, ethyl, n-propyl, isopropyl, n-butyl or isobutyl, but also hexyl, such as n-hexyl, heptyl, such as n-heptyl, octyl, such as n-octyl and isooctyl, nonyl, such as n-nonyl, decyl, such as n-decyl, dodecyl, such as n-dodecyl or octadecyl, such as n-octadecyl. The same holds for alkoxy and alkylene groups, mutatis mutandis.

Aryl preferably stands for phenyl and naphthyl and arylene for phenylene, in particular 1,2-, 1,3- and 1,4-phenylene and naphthylene, such as, in particular, 1,4-, 1,5- and 1,8-naphthylene.

Halogen is in particular fluorine, chlorine and bromine.

Present invention dyes of formula (1) where r is 0 have the formula (1a)

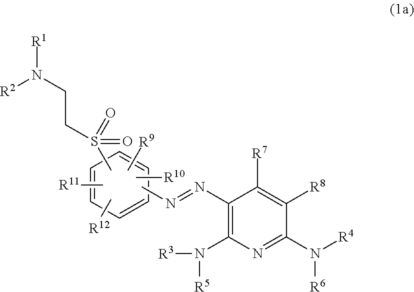

where R¹ to R¹² are each as defined above. Compounds of formula (1a) are preferred.

Present invention dyes of formula (1) where r is 1 have the formula (1b)

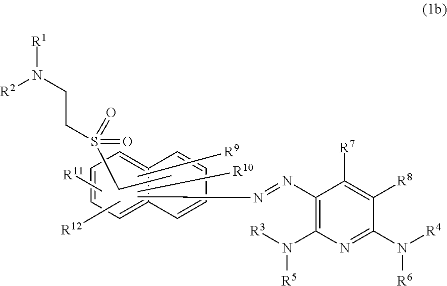

where R¹ to R¹² are each as defined above.

In preferred dyes of formula (1), (1a) and (1b), R³ and R⁴ are each hydrogen, R⁷ is methyl and R⁸ is cyano and also R⁵ and R⁶ independently are phenyl, (C₁-C₄)-alkyl or (C₁-C₄)-alkyl interrupted by —O—.

In further preferred dyes of formula (1), the radicals of the formulae (OE1) and (OE2) are attached to R² and/or R⁵ and/or R⁶ as well as to R¹.

In further preferred dyes, R⁹ to R¹² independently are hydrogen, (C₁-C₄)-alkyl or (C₁-C₄)-alkoxy. When r is 0, R¹¹ and R¹² are particularly preferably hydrogen. In further preferred dyes, R¹ and R² independently are (C₁-C₄)-alkyl. In further preferred dyes, R²⁹ (or as the case may be R²¹) is hydrogen, z (and as the case may be t) independently are a number from 1 to 10 and y (and as the case may be s) independently are a number from 0.1 to 10.

Particularly preferred dyes of the present invention conform to the general formula (1c)

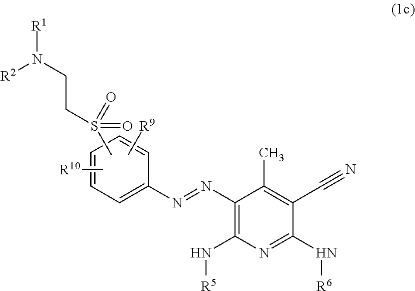

where
R¹, R², R⁵, R⁶, R⁹ and R¹⁹ are each as defined above and, more particularly, have the preferred meanings indicated above and the radicals of the formulae (OE1) and (OE2) are attached to R¹ and R⁵ or to R¹ and R⁶ or to R¹, R² and R⁵ or to R¹, R² and R⁶ or to R¹, R⁵ and R⁶ or to R¹, R², R⁵ and R⁶.

The dyes of formula (1) according to the present invention are obtainable for example by a compound of formula (2)

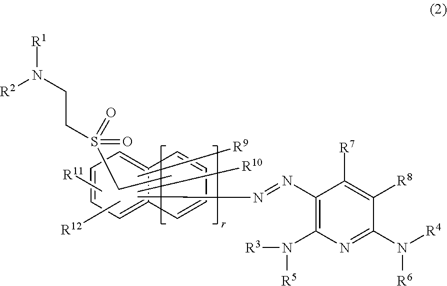

where
R¹ is aryl or (C₁-C₆₀)-alkyl which may each be substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —COOR¹⁴, —CONR¹⁵R¹⁶ or cyano and in the case of (C₁-C₆₀)-alkyl may be interrupted by arylene, —O—, —CO—, —COO—, —CONH—, —SO₂— or —NR¹³—;
R², R³, R⁴, R⁵ and R⁶ independently are hydrogen or have one of the meanings of R¹;
R⁷ is hydrogen or (C₁-C₄)-alkyl;
R⁸ is cyano, carbamoyl or sulfomethyl;
R⁹ to R¹² independently are hydrogen, have one of the meanings of R¹ or are hydroxyl, (C₁-C₄)-alkoxy, hydroxy-(C₁-C₄₀)alkyl, (C₂-C₄₀)-alkylene, halogen, —NHSO₂—, —COOR¹⁴, —CONR¹⁵R¹⁶ or cyano; or
any two of the R⁹ to R¹² radicals which are ortho to each other combine with the carbon atoms to which they are attached to form a 5- or 6-membered ring which may be substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —NHSO₂—, —COOR¹⁴, —CONR¹⁵R¹⁶ or cyano;
R¹³ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁴ is aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁵ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁶ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
r is 0 or 1; and
R¹ and at least one of the R² to R¹² radicals each have at least one hydroxyl group, being reacted with at least one compound of formula (3a)

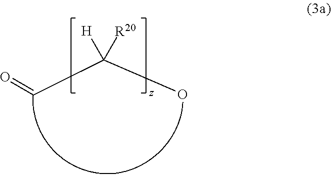

where R²⁰ and z are each as defined above.

Having regard to the group of the formula (OE2), the compound of formula (2) is reacted with a compound of formula (3a) and with a compound of formula (3b)

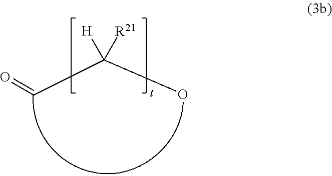

where R²¹ and t are each as defined above.

The compounds of formula (2) can also be present as mixtures, in particular as isomeric mixtures.

The reaction is carried out in the presence of a catalyst, preferably at temperatures of 80 to 200° C. and more preferably at 110 to 170° C. Suitable catalysts are for example Lewis acid catalysts, including for example metal halides, metal oxides, metal carboxylates and organometallic compounds. Representatives of this group are tin octoate, (Sn(II) di(ethyl-2-hexanoate) and dibutyltin dilaurate. Further examples of Lewis acid catalysts are Sn(Ph)₄, SnBr₄, Sn(Oct)₂, Zn(Ac)₂, Sb₂O₅.

Suitable catalysts or initiators further include metal alkoxides, for example alkoxides of magnesium, of tin, of titanium, of zirconium, of zinc and of aluminum.

The compounds of formula (2) are known and obtainable for example by methods indicated in WO 2007/039525. These methods give many of the compounds of formula (2) in the form of mixed isomers. Herein, the notation

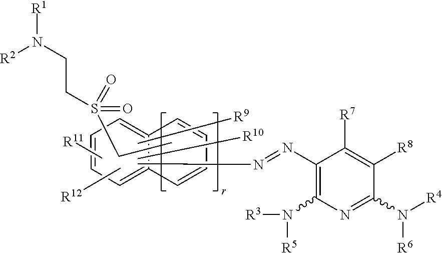

represents such a mixture of isomers. For instance, the formula

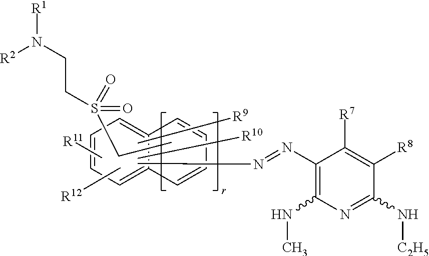

represents a mixture of the isomers

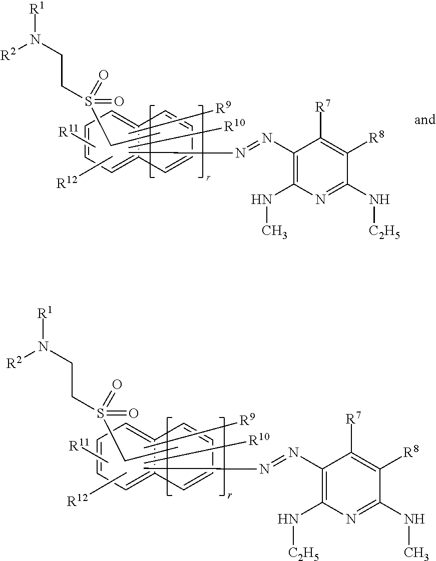

Preferred compounds of formula (2) are the compounds formulae (2a) to (2ag)

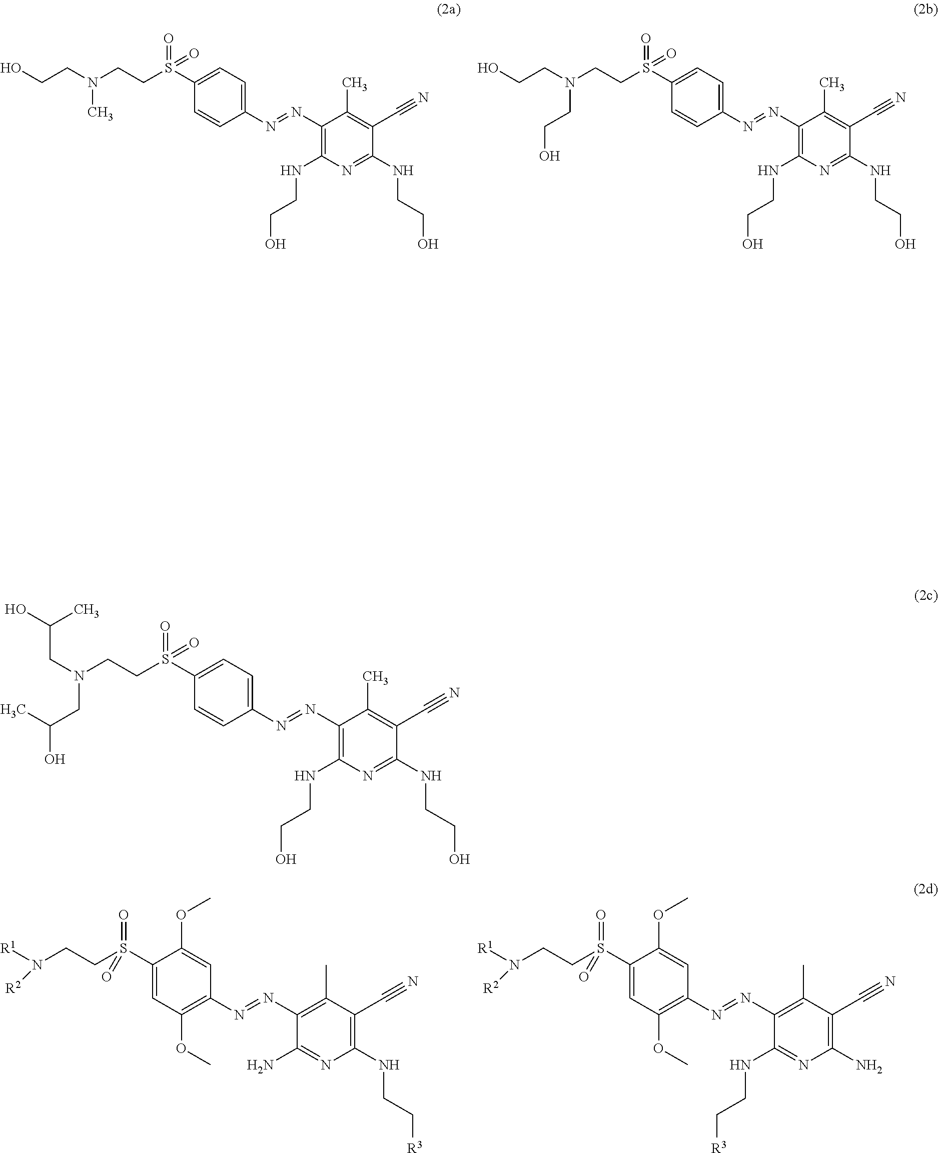

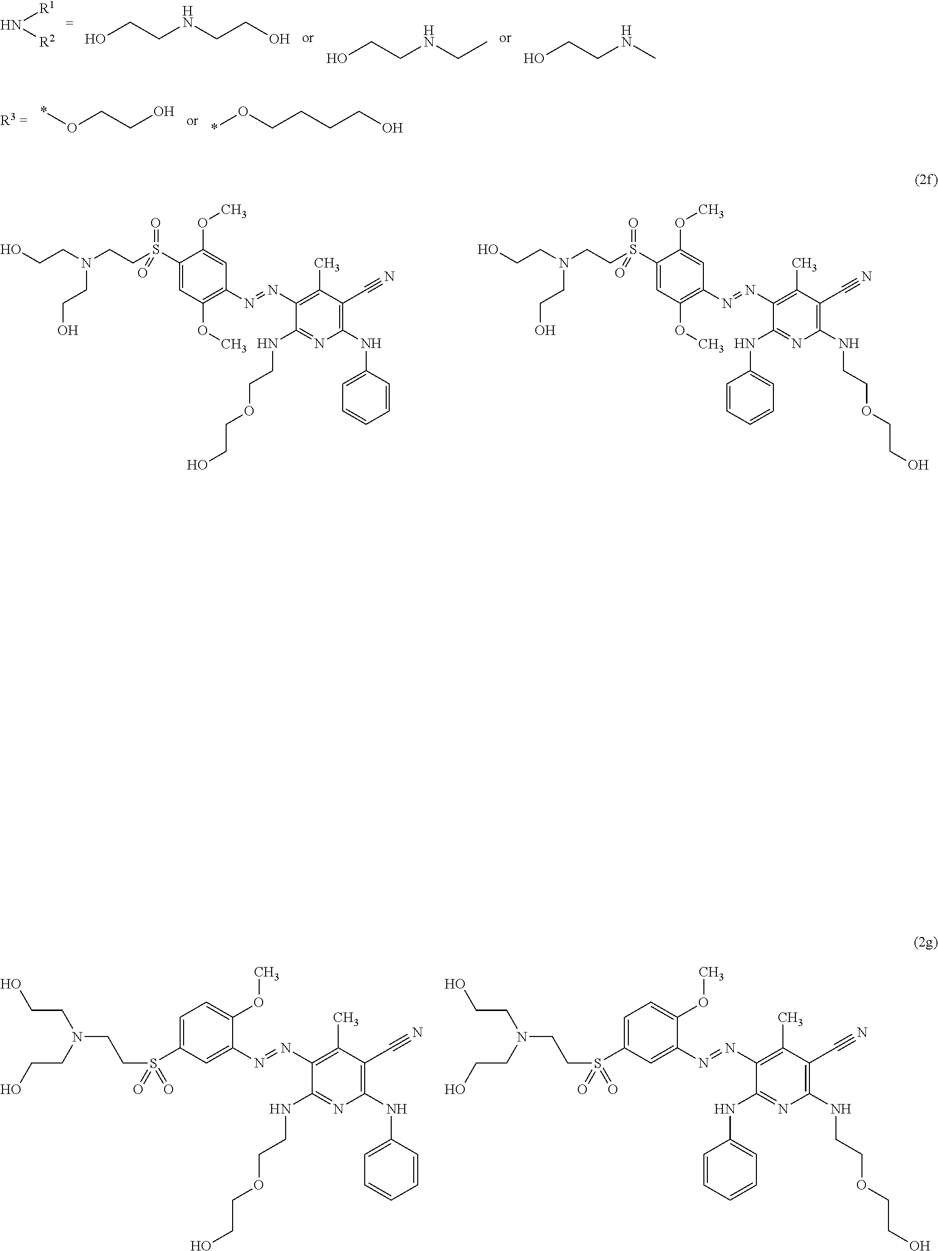

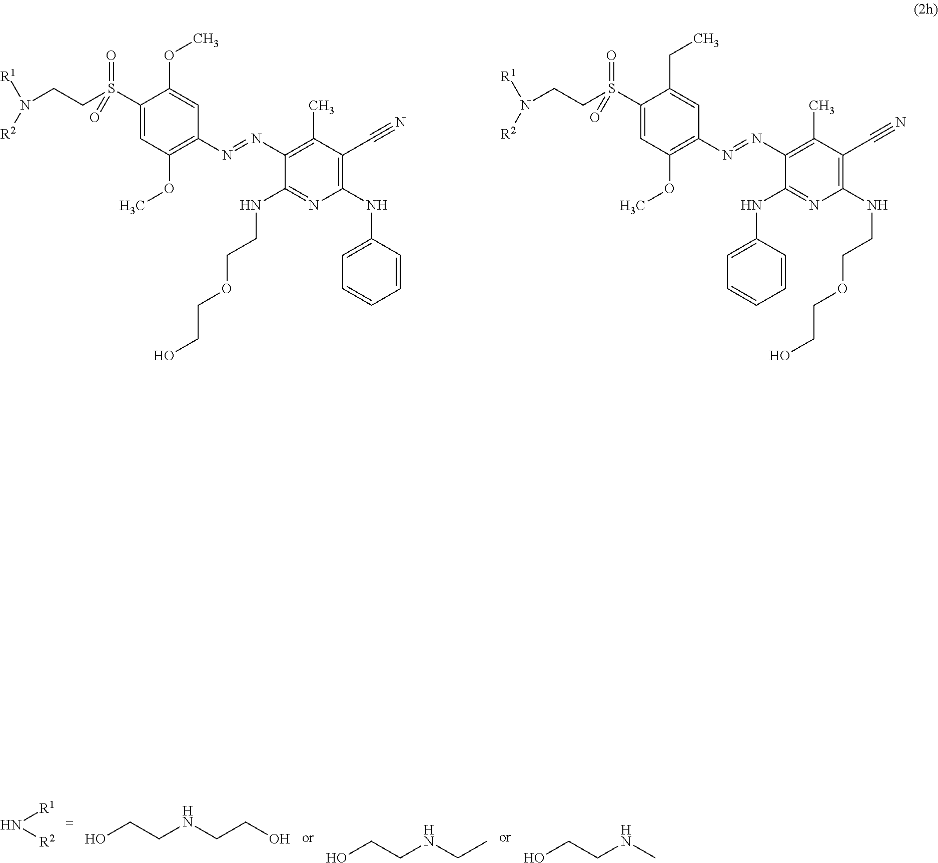

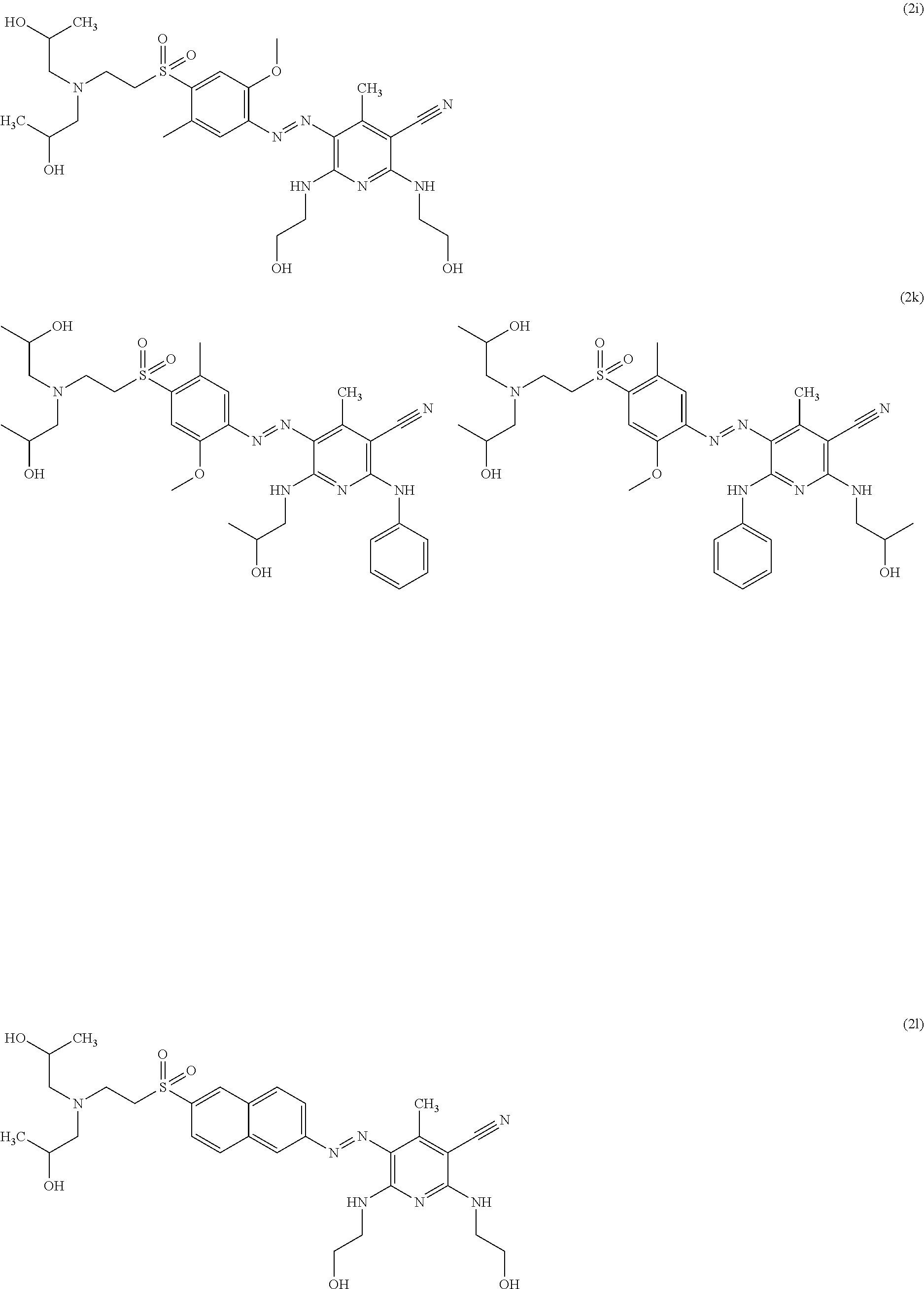

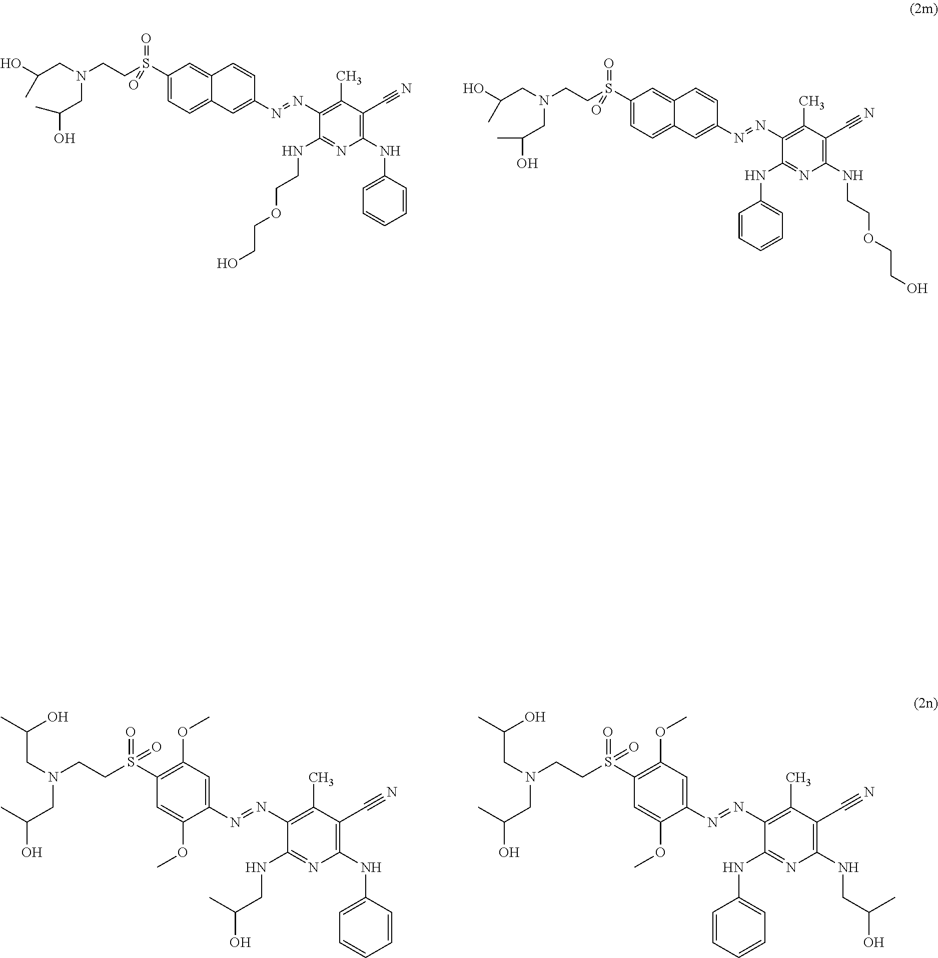

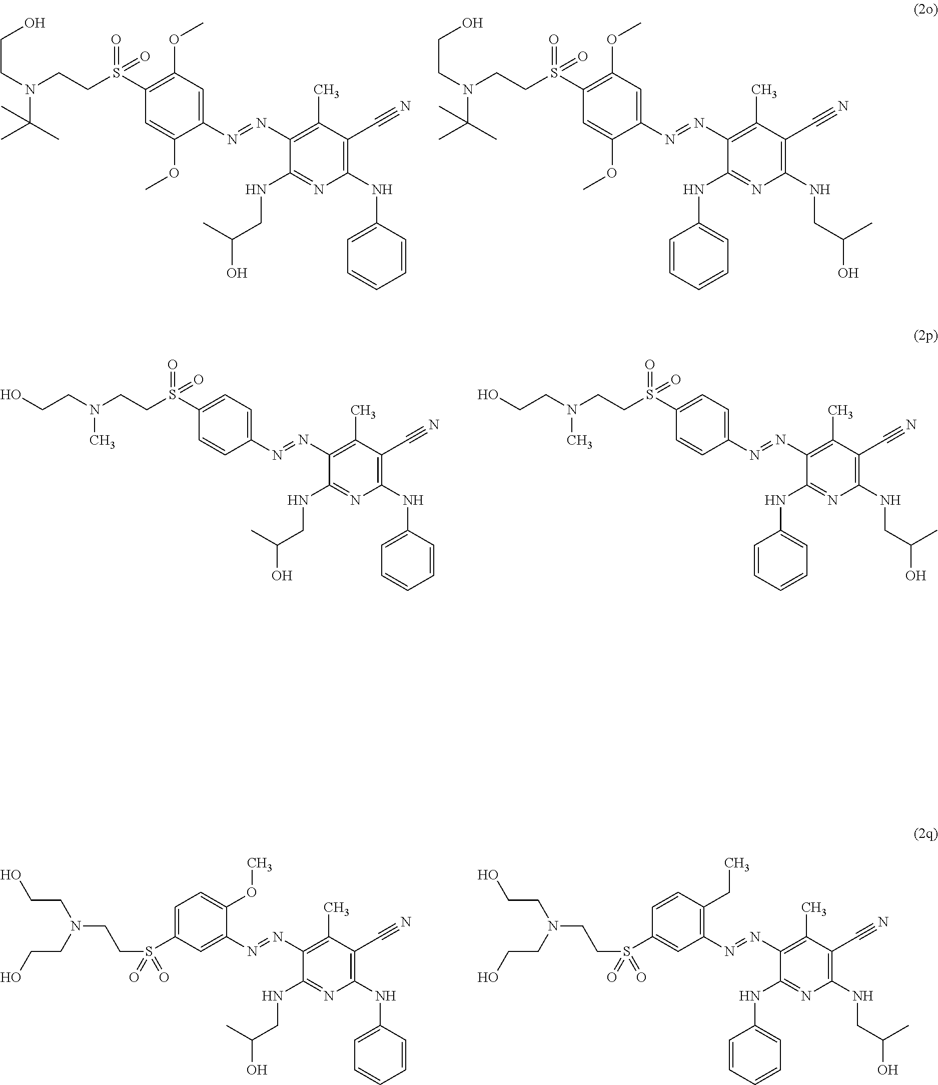

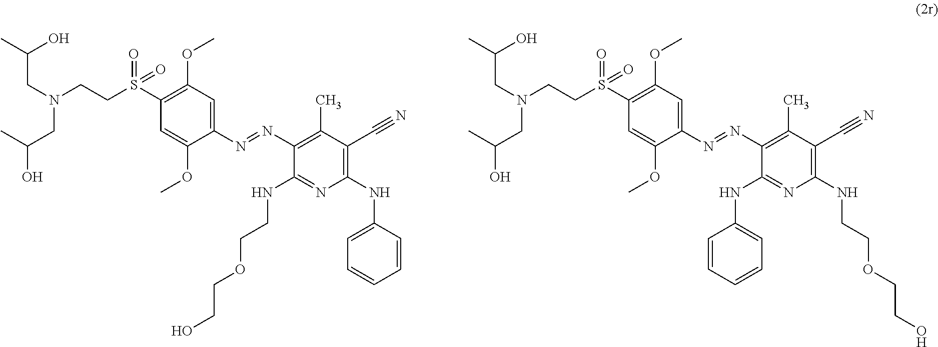

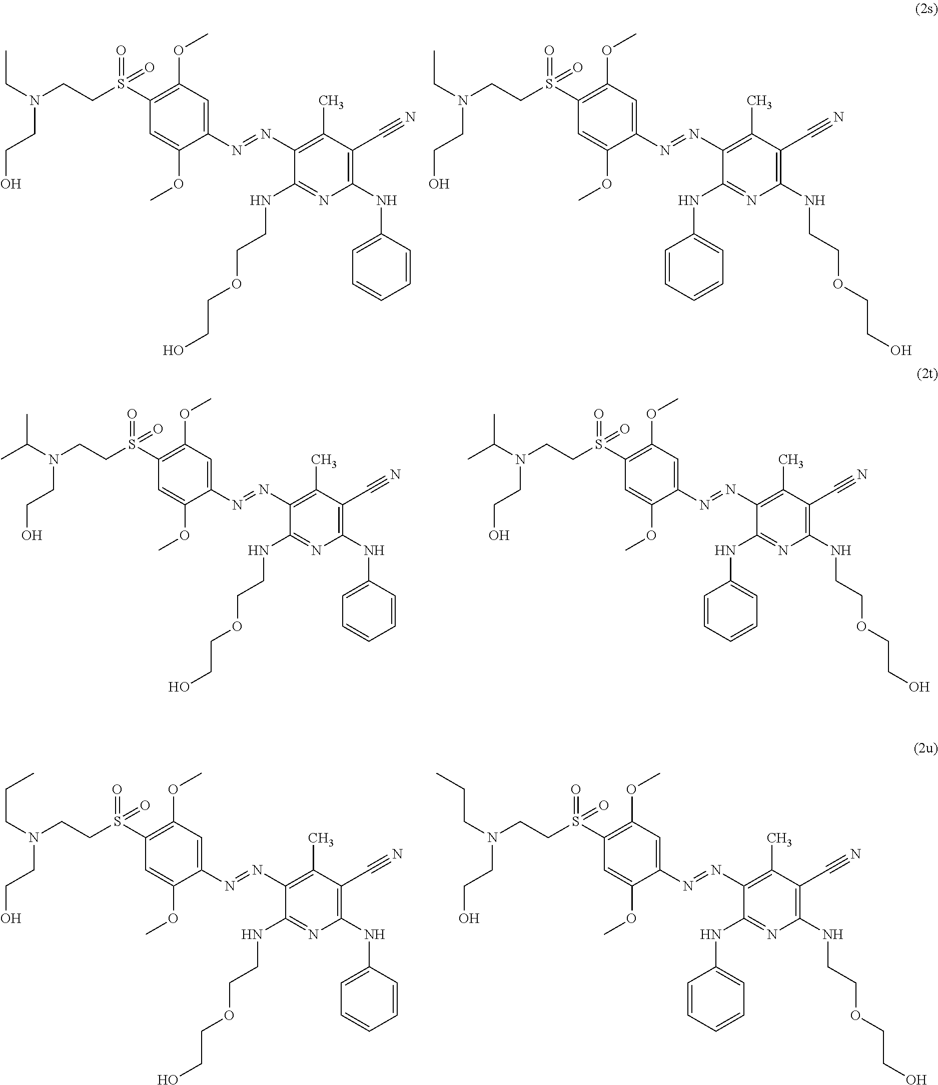

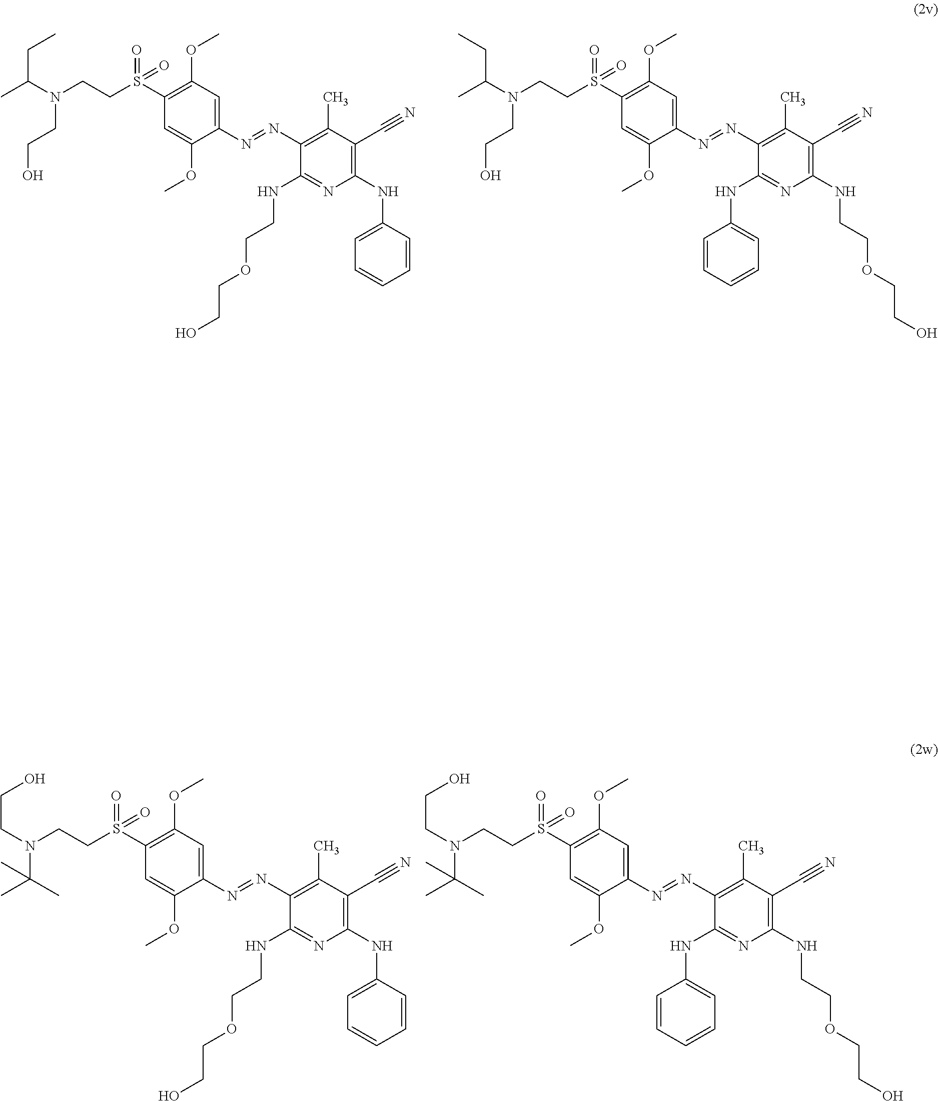

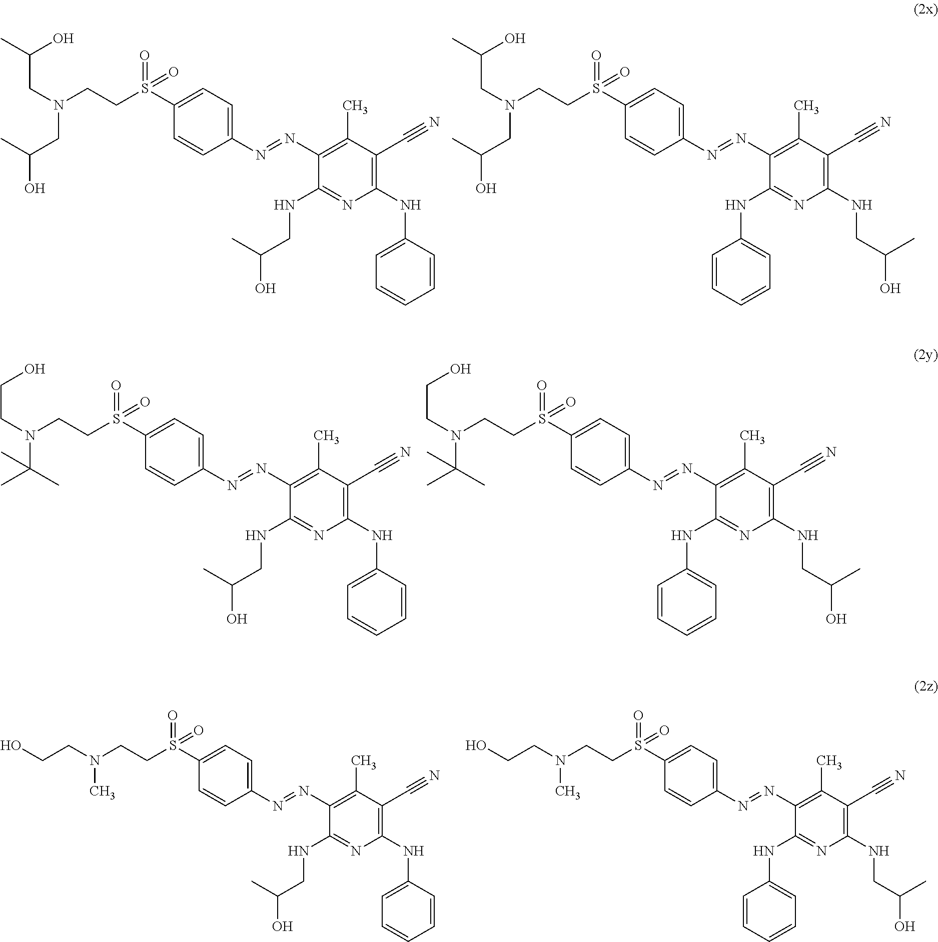

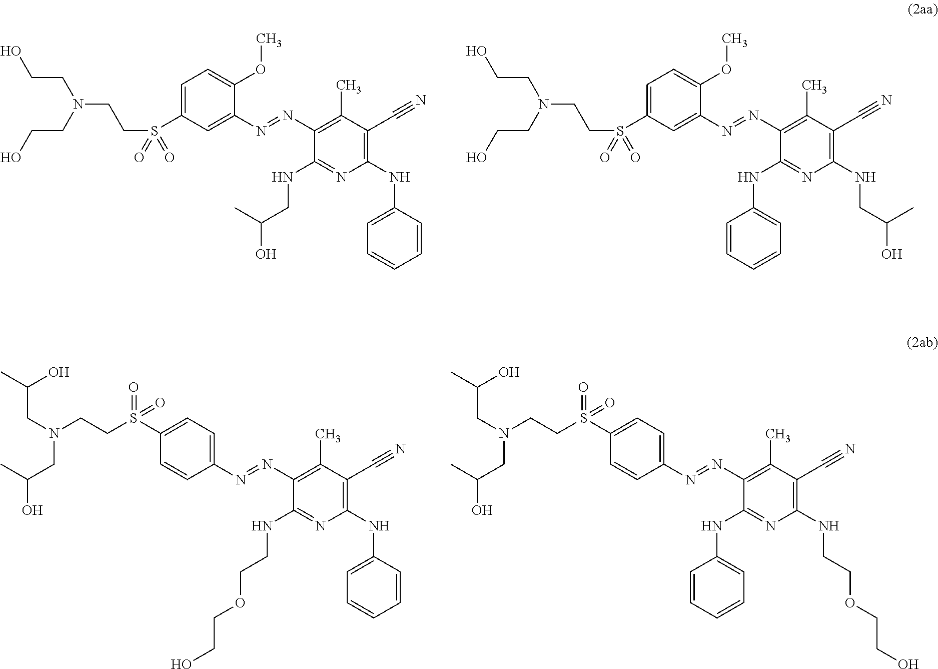

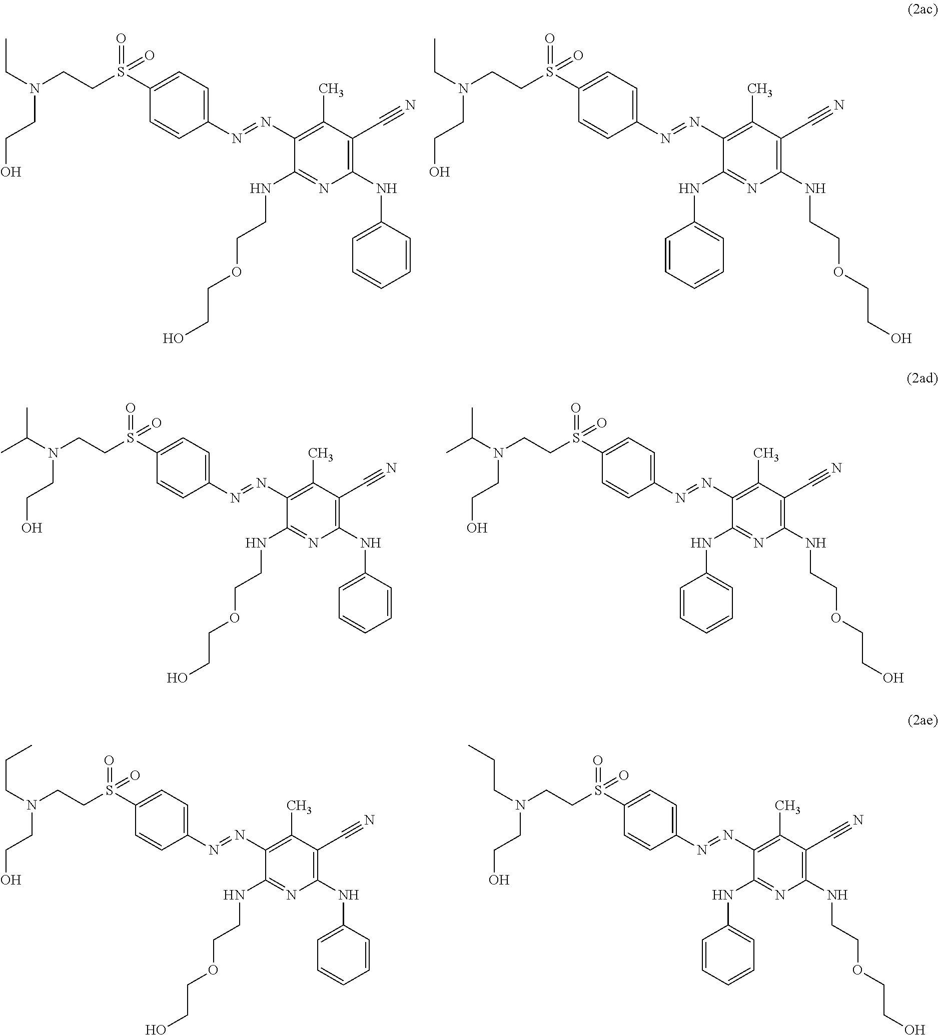

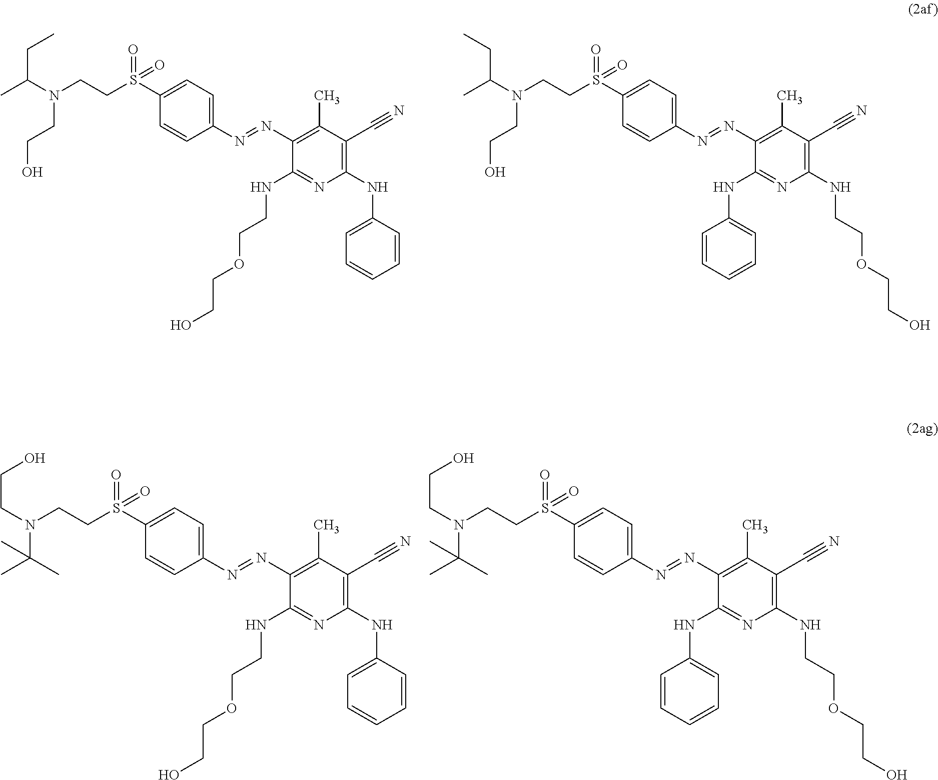

The compounds of formulae (3a) and (3b) are lactones, and the compounds of formulae (3c) to (3g) are particularly preferred.

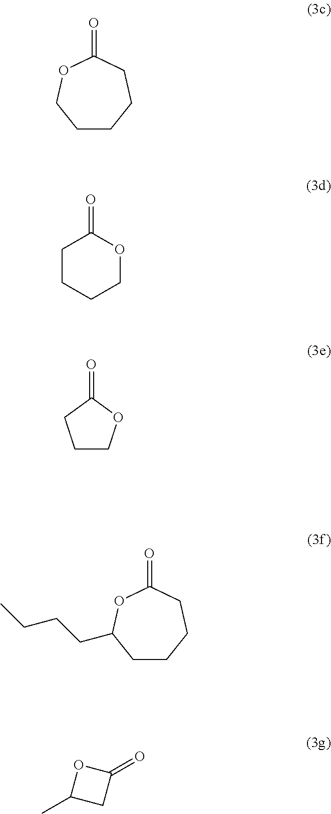

The compounds of formulae (3a) and (3b) are likewise known and obtainable by known methods.

The oligomerization of the lactones of formulae (3a) and (3b) in the course of the preparation of the dyes of formula (1) according to the present invention naturally does not proceed unitarily in that mixtures are produced. The numbers y and s are therefore mean values.

Depending on the choice of starting compounds, the present invention preparation of the compounds of formula (1) gives rise to dye mixtures which likewise form part of the subject matter of the present invention.

The present invention accordingly provides dye mixtures comprising at least two dyes of formula (1).

After they have been prepared, the dyes of formula (1) can be isolated by extraction and evaporation, or they can be used without further workup.

The present invention's dyes and dye mixtures can be used directly for polymer coloration, or they are subjected to a finishing operation. Finishing can be effected proceeding from a single dye or a mixture of a plurality of dyes and also mixtures with other dye classes such as for example pigments or solvent dyes, if appropriate with the assistance of auxiliaries, for example surface modifiers, dispersants by dispersing, suspending or dissolving in a liquid or solid carrier material and also if appropriate standardizing to a desired color strength and a desired hue and if appropriate drying the preparation thus obtained.

Dye preparations comprising dyes of formula (1) may also include auxiliaries for modifying the viscosity or flowability. Suitable auxiliaries of this kind are described for example in U.S. Pat. No. 6,605,126 and are in particular auxiliaries which, under the particular conditions, are themselves capable of polymer formation. Preferred examples are ethylene glycols, propylene glycols, polyether polyols, polyester polyols, lactones and carbonic esters. Caprolactone, butyrolactone and propylene carbonate are very particularly preferred.

The present invention accordingly also provides dye preparations comprising one or more dyes of formula (1) and also dye preparations comprising one or more dyes of formula (1) and one or auxiliaries for modifying the viscosity or flowability. The latter dye preparations preferably comprise one or more dyes of formula (1) in amounts of 50% to 99% by weight and one or more dyes for modifying the viscosity or flowability in amounts of 1% to 50% by weight, all based on the dye preparation.

The present invention further provides for the use of the present invention dyes of formula (1) for coloring a polymer. A possible procedure is for the dye to be metered into the polymer or the reaction mixture during the polymerization or to be admixed to one of the starting materials before the polymerization.

The compounds of formula (1) are preferably used for coloring polyurethane by the compounds of the present invention either being added during the polymerization of diol/polyol and isocyanate or being added to one of the starting materials before the polymerization. For example, the present invention dye of formula (1) can be admixed to a polyether polyol or to a polyester polyol, and this preparation can then be used for the polymerization with a diisocyanate. It is customary to use the above-mentioned stabilizers, activators or catalysts in the polymerization.

Polyurethane foam is produced according to the same principle, the foam being produced by the addition of blowing gas or by the addition of water, leading to the formation of carbon dioxide blowing gas, to the diol/polyol component or to the reaction mixture of the polymerization. Using the present invention dyes of formula (1) it is thus possible to produce colored polyurethane foams having good fastnesses.

The processes described above polymerize the present invention dyes of formula (1) into the polymer scaffold. But the present invention dyes of formula (1) are also suitable for coloring polymers without a chemical bond having to be formed with the polymer scaffold.

For this purpose, they can be used in the processes known for the mass coloration of polymers, in which case they are used in particular in the form of masterbatches or solutions or in the form of the preparations described above.

To achieve good bleed fastnesses for the colored polymer, it is preferable to use dyes of sufficiently high molar mass.

The dyes of formula (1) have advantages in bleed or migration fastness over the commercially available solvent dyes in the polymer mass coloration of polyolefins in particular. These advantages come into effect in the coloration of polypropylene, polypropylene-co-polymers and polypropylene blends.

The examples hereinbelow serve to elucidate the invention without restricting the invention to these examples. Parts and percentages are by weight, unless otherwise stated. Parts by weight relate to parts by volume as the kilogram to the liter.

### EXAMPLE 1

a) To 28 parts of ε-caprolactone of formula (3c) are added with stirring at 120° C. 40.9 parts of the disperse dye of formula (2y) and thoroughly stirred in. Then, 0.0625 part of dibutyltin dilaurate, dissolved in 0.5 part of ε-caprolactone, is added to the mixture, the mixture is heated to 150° C. and stirred at 150° C. for 24 hours.

After cooling, the dye of formula (1-1) is obtained, and it constitutes as described above an isomeric mixture

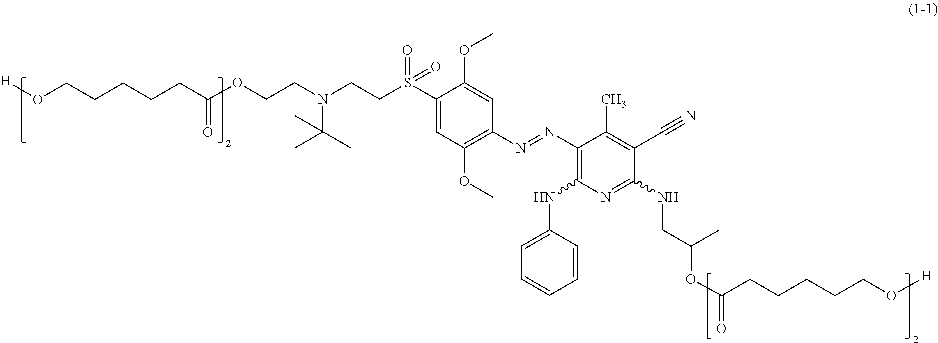

where y has a mean value of 2.

b) To 15 parts of the dye (1-1) are added 3 parts of γ-butyrolactone and the mixture is heated to 80° C. for one hour with stirring. After cooling, a liquid dye preparation is obtained.

c) To 15 parts of the dye (1-1) are added 3 parts of propylene carbonate and the mixture is heated to 80° C. for one hour with stirring. After cooling, a liquid dye preparation is obtained.

### EXAMPLE 2

a) To 56 parts of ε-caprolactone of formula (3c) are added with stirring at 120° C. 55.8 parts of the disperse dye of formula (2×) and thoroughly stirred in. Then, 0.125 part of dibutyltin dilaurate, dissolved in 1 part of ε-caprolactone, is added to the mixture, the mixture is heated to 150° C. and stirred at 150° C. for 24 hours.

After cooling, the dye of formula (1-2) is obtained, and it constitutes as described above an isomeric mixture

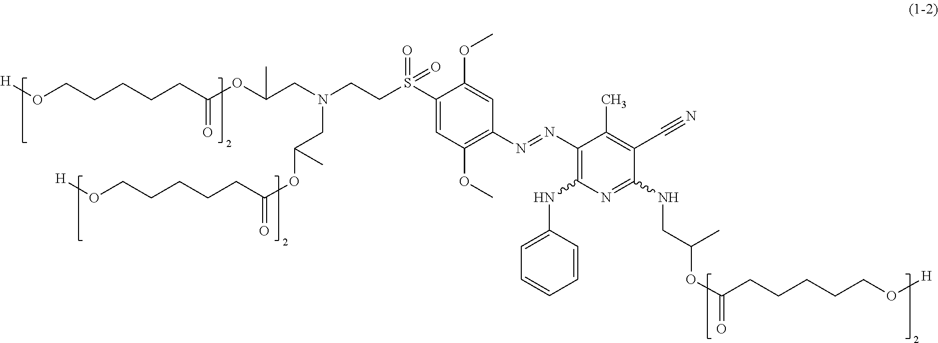

where y has a mean value of 2.

b) To 20 parts of the dye (1-2) are added 4 parts of γ-butyrolactone and the mixture is heated to 80° C. for one hour with stirring. After cooling, a liquid dye preparation is obtained.

c) To 20 parts of the dye (1-2) are added 4 parts of propylene carbonate and the mixture is heated to 80° C. for one hour with stirring. After cooling, a liquid dye preparation is obtained.

### EXAMPLE 3

a) To 42.5 parts of e-decalactone of formula (3f) are added with stirring at 120° C. 42.7 parts of the disperse dye of formula (2ag) and thoroughly stirred in. Then, 0.0625 part of dibutyltin dilaurate, dissolved in 0.5 part of c-decalactone, is added to the mixture, the mixture is heated to 150° C. and stirred at 150° C. for 24 hours.

After cooling, the dye of formula (1-3) is obtained, and it constitutes as described above an isomeric mixture

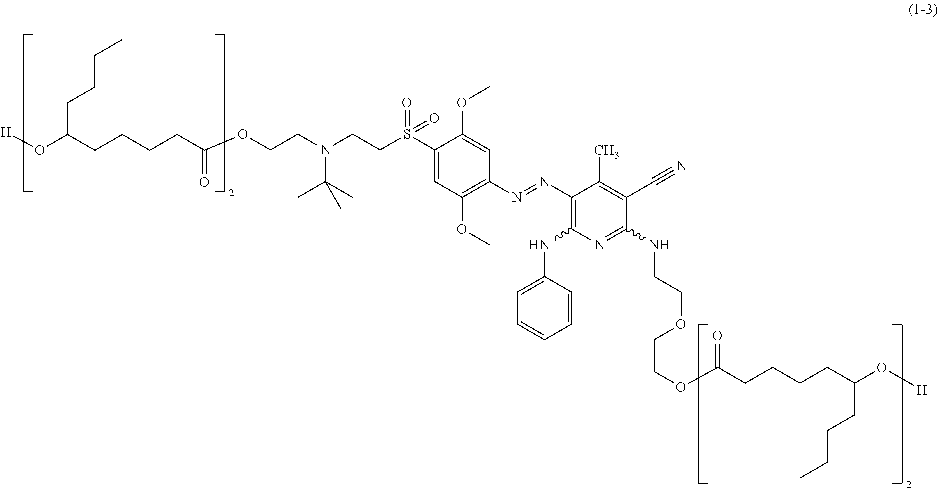

b) To 15 parts of the dye (1-3) are added 3 parts of γ-butyrolactone and the mixture is heated to 80° C. for one hour with stirring. After cooling, a liquid dye preparation is obtained.

c) To 15 parts of the dye (1-3) are added 3 parts of propylene carbonate and the mixture is heated to 80° C. for one hour with stirring. After cooling, a liquid dye preparation is obtained.

### EXAMPLE 4

To 56 parts of ε-caprolactone of formula (3a) are added with stirring at 120° C. 58.3 parts of the disperse dye of formula (2ab) and thoroughly stirred in. Then, 0.125 parts of tin(II) 2-(bis(ethylhexanoate)), dissolved in 1 part of ε-caprolactone, is added to the mixture, the mixture is heated to 150° C. and stirred at 150° C. for 24 hours.

After cooling, the dye of formula (1-4) is obtained, and it constitutes as described above an isomeric mixture

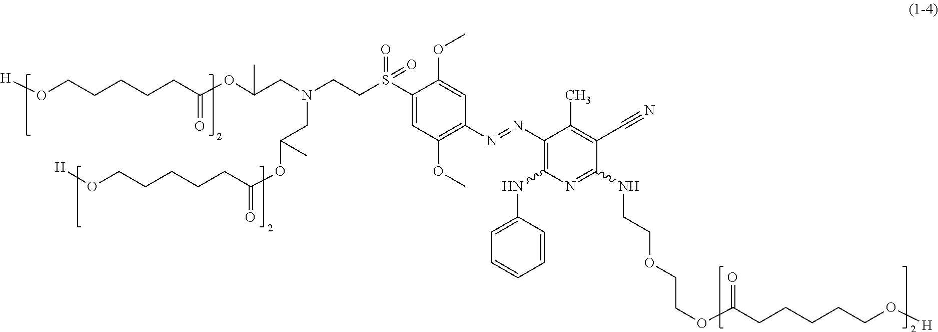

where y has a mean value of 2.

b) To 20 parts of the dye (1-4) are added 4 parts of γ-butyrolactone and the mixture is heated to 80° C. for 0.5 hour with stirring. After cooling, a liquid dye preparation is obtained.

c) To 20 parts of the dye (1-4) are added 4 parts of propylene carbonate and the mixture is heated to 80° C. for 0.5 hour with stirring. After cooling, a liquid dye preparation is obtained.

### EXAMPLE 5

a) To a mixture of 45.6 parts of ε-caprolactone of formula (3c) and 8.6 parts of γ-butyrolactone of formula (3e) are added with stirring at 120° C. 58.3 parts of the disperse dye of formula (2ab) and thoroughly stirred in. Then, 0.0125 part of dibutyltin dilaurate, dissolved in 1 part of ε-caprolactone, is added to the mixture, the mixture is heated to 150° C. and stirred at 150° C. for 24 hours.

After cooling, the dye of formula (1-5) is obtained, and it constitutes as described above an isomeric mixture

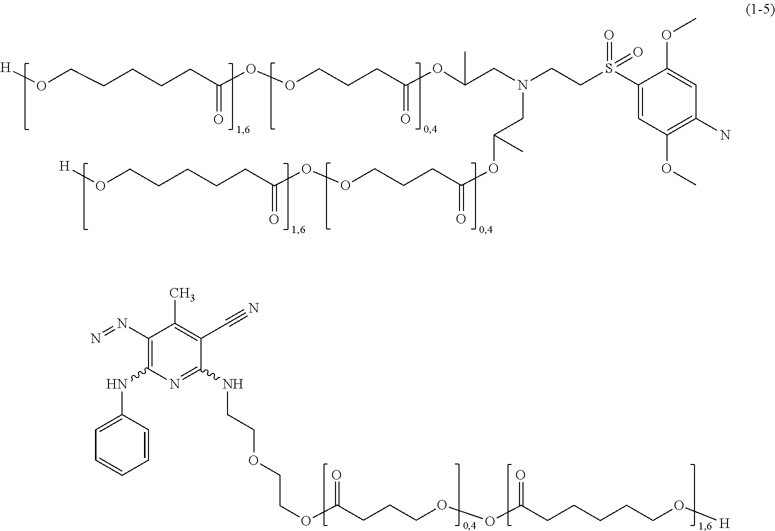

where y has a mean value of 1.6 and s has a mean value of 0.4. The dye obtained is depicted in formula (1-5) for clarity as a block polymer by way of example. However, the oligoester side chains in fact form a random distribution.

b) To 20 parts of the dye (1-5) are added 4 parts of γ-butyrolactone and the mixture is heated to 80° C. for 0.5 hour with stirring. After cooling, a liquid dye preparation is obtained.

c) To 20 parts of the dye (1-4) are added 4 parts of propylene carbonate and the mixture is heated to 80° C. for 0.5 hour with stirring. After cooling, a liquid dye preparation is obtained.

### EXAMPLE 6

a) To 56 parts of ε-caprolactone of formula (3c) are added with stirring at 120° C. 58.3 parts of the disperse dye of formula (2ab) and thoroughly stirred in. Then, 0.125 part of dibutyltin dilaurate, dissolved in 1 part of ε-caprolactone, is added to the mixture, the mixture is heated to 150° C. and stirred at 150° C. for 24 hours.

After cooling, the dye of formula (1-4) is obtained, and it constitutes as described above an isomeric mixture

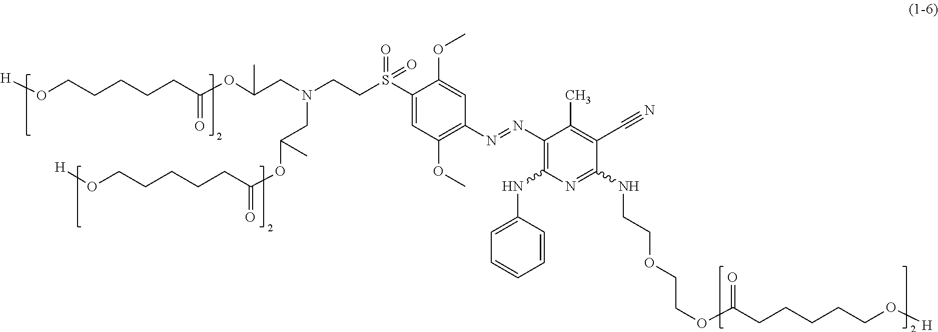

where y has a mean value of 2.

b) To 50 parts of the dye (1-6) are added 10 parts of γ-butyrolactone and the mixture is heated to 80° C. for 0.5 hour with stirring. After cooling, a liquid dye preparation is obtained.

c) To 50 parts of the dye (1-6) are added 10 parts of propylene carbonate and the mixture is heated to 80° C. for 0.5 hour with stirring. After cooling, a liquid dye preparation is obtained.

### EXAMPLE 7

a) To 56 parts of ε-caprolactone of formula (3c) are added with stirring at 120° C. 116.6 parts of the disperse dye of formula (2ab) and thoroughly stirred in. Then, 0.125 part of dibutyltin dilaurate, dissolved in 1 part of ε-caprolactone, is added to the mixture, the mixture is heated to 150° C. and stirred at 150° C. for 24 hours.

After cooling, the dye of formula (1-7) is obtained, and it constitutes as described above an isomeric mixture

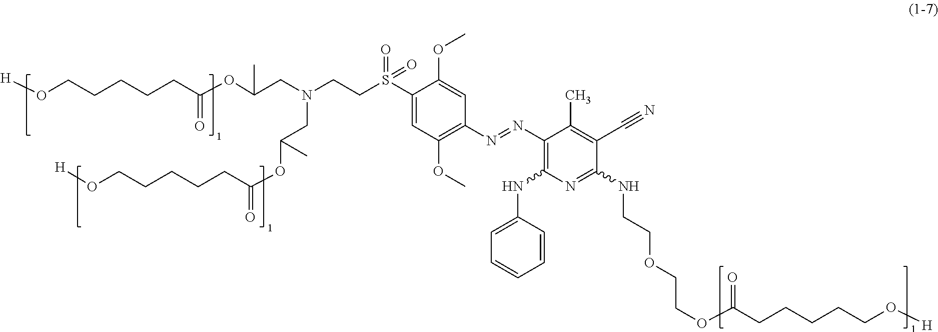

where y has a mean value of 1.

b) To 20 parts of the dye (1-7) are added 10 parts of γ-butyrolactone and the mixture is heated to 80° C. for 0.5 hour with stirring. After cooling, a liquid dye preparation is obtained.

c) To 20 parts of the dye (1-7) are added 4 parts of propylene carbonate and the mixture is heated to 80° C. for 0.5 hour with stirring. After cooling, a liquid dye preparation is obtained.

### EXAMPLE 8

a) To 56 parts of ε-caprolactone of formula (3c) are added with stirring at 120° C. 42.1 parts of the disperse dye of formula (2a) and thoroughly stirred in. Then, 0.125 part of dibutyltin dilaurate, dissolved in 1 part of ε-caprolactone, is added to the mixture, the mixture is heated to 150° C. and stirred at 150° C. for 24 hours.

After cooling, the dye of formula (1-8) is obtained

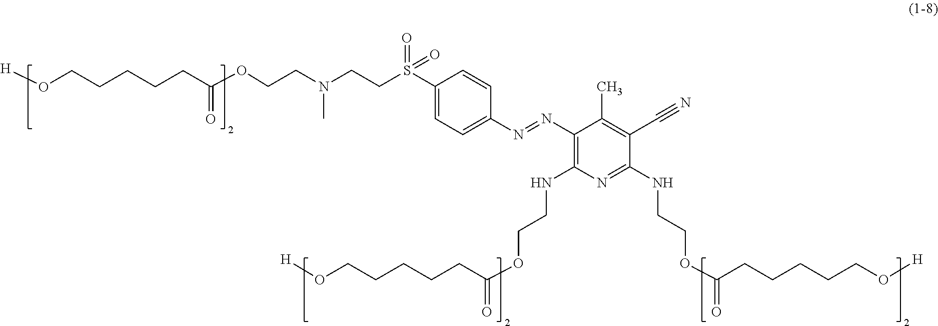

where y has a mean value of 2.

b) To 20 parts of the dye (1-8) are added 4 parts of γ-butyrolactone and the mixture is heated to 80° C. for 0.5 hour with stirring. After cooling, a liquid dye preparation is obtained.

c) To 20 parts of the dye (1-8) are added 10 parts of propylene carbonate and the mixture is heated to 80° C. for 0.5 hour with stirring. After cooling, a liquid dye preparation is obtained.

### EXAMPLE 9

0.41 part of the dye mixture conforming to formulae (I-6) of Example 6 is dissolved in one part of N-methylpyrrolidone (NMP).

100 parts of the Elastopan S 7521/102 polyol component from Elastogran GmbH are initially charged. One part of the dye-NMP solution described above is added to the initial charge. The mixture is vigorously stirred by means of a dissolver disc for 20-30 seconds. Then, 60 parts of IsoMMDI 92220 diisocyanate from Elastogran GmbH are expeditiously added and intensively stirred by means of the dissolver disc for 7 seconds. The mixture is then poured into a vessel for forming the foam, vessels composed of paper or paperboard being suitable. After about 5 minutes, the components will have reacted and after a further 10 minutes the foam will be fully cured. The foam is allowed to cool to room temperature. 20 minutes after having cooled down, the foam is sawn open to assess its color. The foam is found to have a brilliant reddish-orange color and good fastnesses to perchloroethylene.

0.51 part of the dye preparation according to Example 6b are used for coloration in the same way, except without prior dissolution in NMP solvent. Similarly, the dye preparation according to Example 6c was used for coloration in the above-described manner without prior dissolving in NMP.

### EXAMPLE 10

Example 9 is repeated using 0.4 part of the dye mixture (1-7) of Example 7 to obtain an orange foam which has good fastnesses to perchloroethylene.

### EXAMPLE 11

Example 9 is repeated using 0.4 part of the dye mixture (1-8) of Example 8 to obtain an orange foam which has good fastnesses to perchloroethylene.

The dyes in the table which follows can be prepared and used similarly to the dyes described above.

### EXAMPLE 12

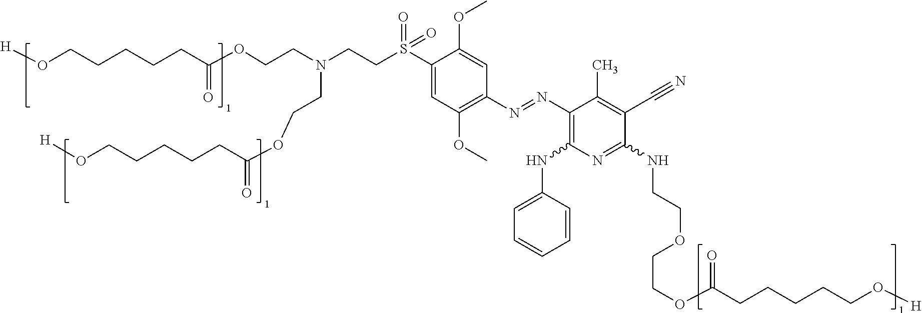

### EXAMPLE 13

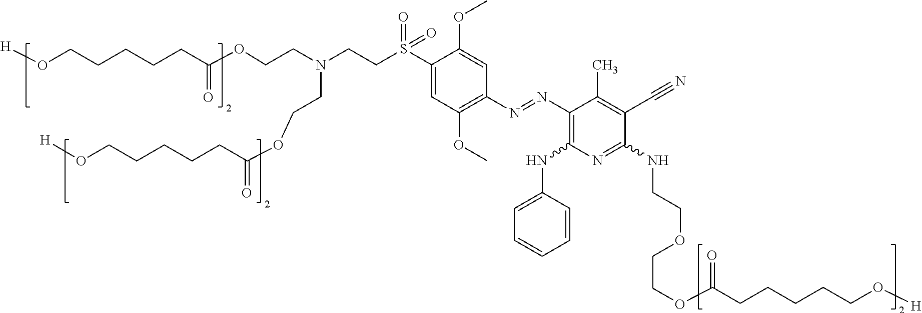

### EXAMPLE 14

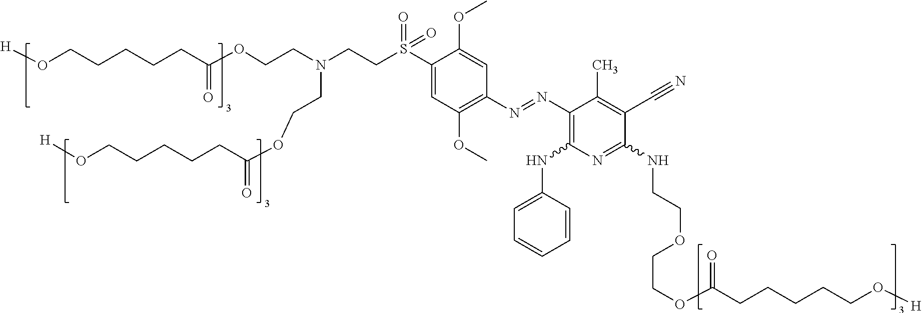

### EXAMPLE 15

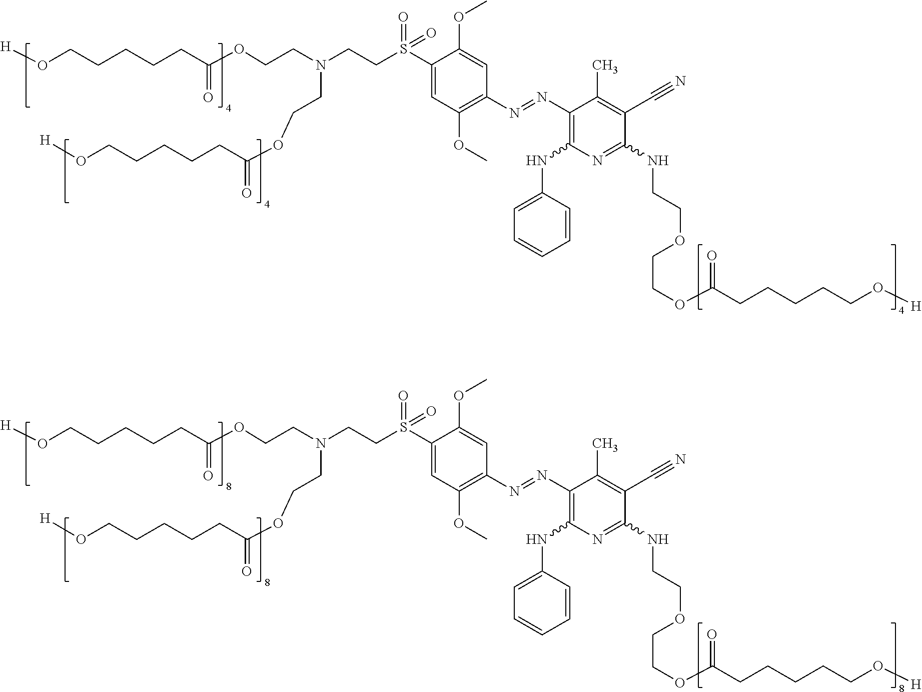

### EXAMPLE 17

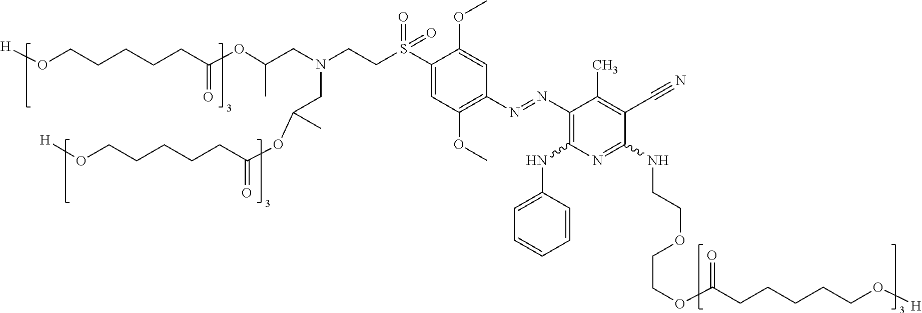

### EXAMPLE 18

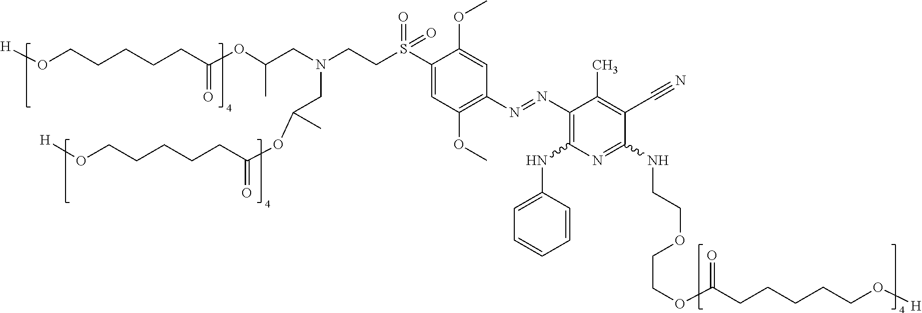

### EXAMPLE 19

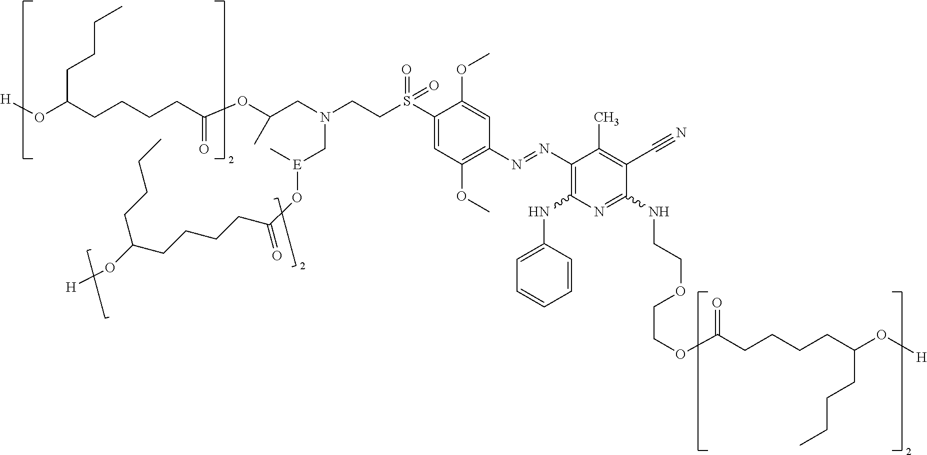

### EXAMPLE 20

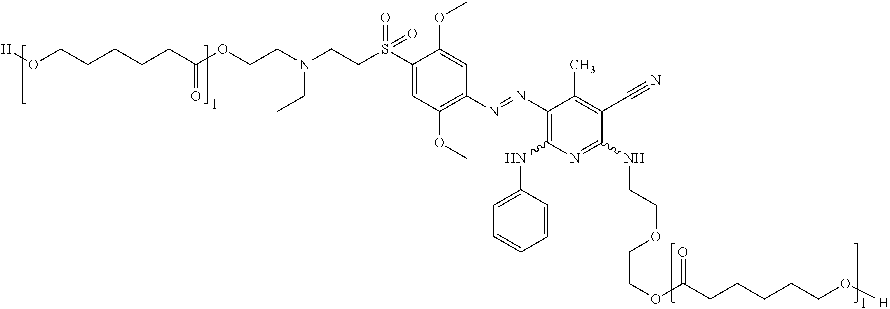

### EXAMPLE 21

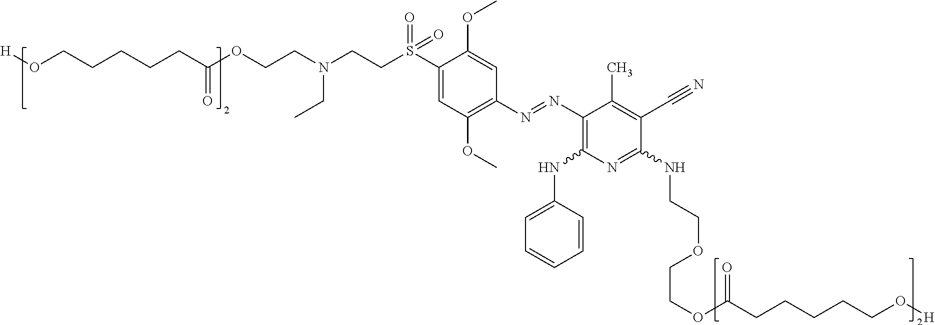

### EXAMPLE 22

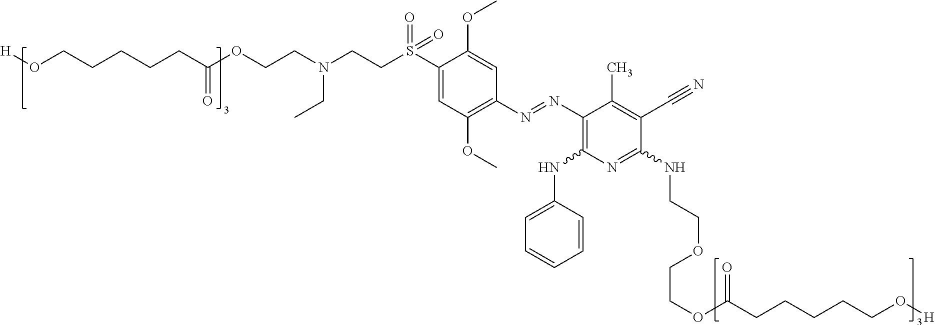

### EXAMPLE 23

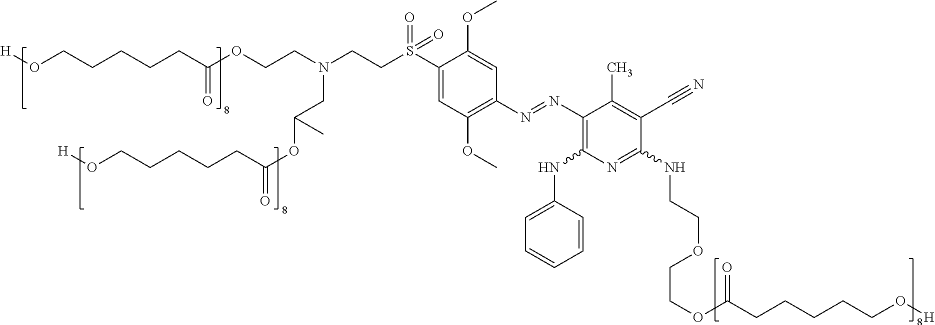

### EXAMPLE 24

Mixture of equal parts each of dyes of the formulae

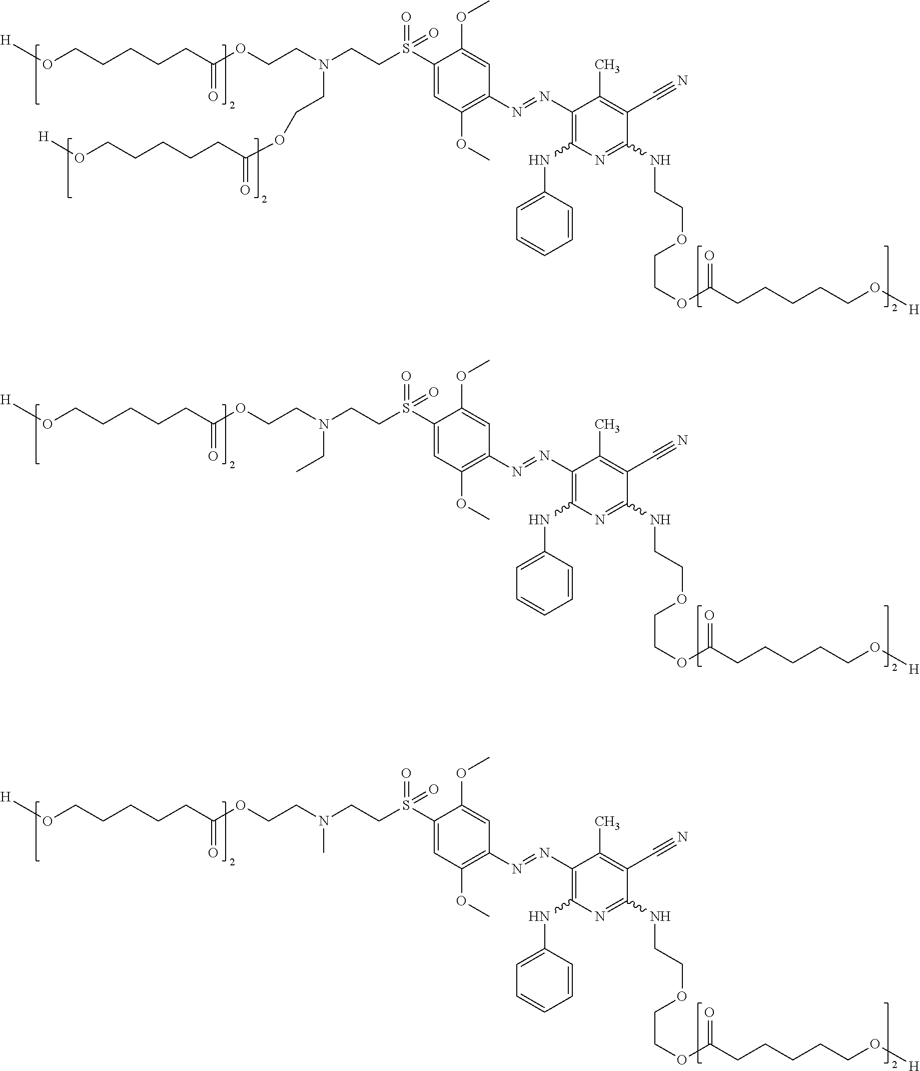

### EXAMPLE 25

### Mixture of Equal Parts Each of Dyes of the Formulae

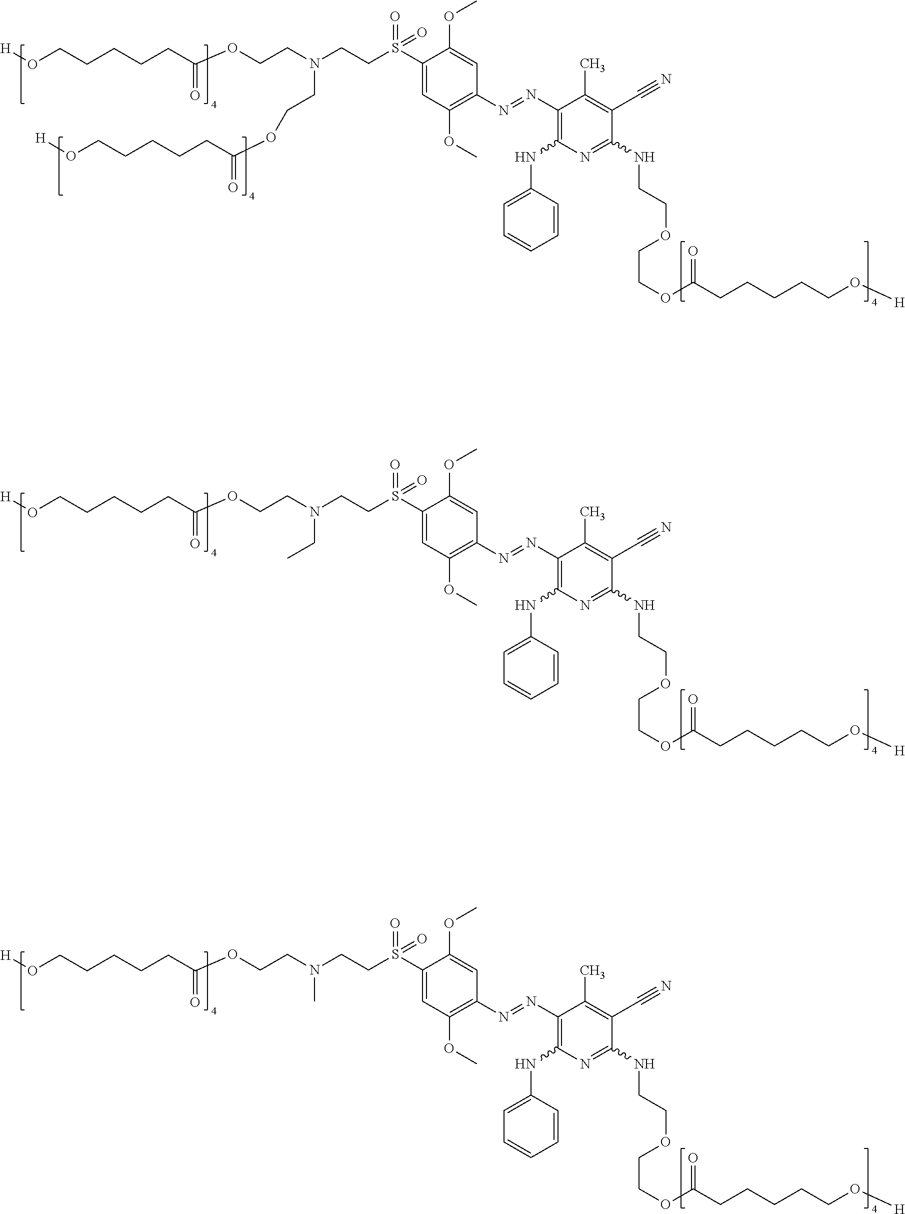

### EXAMPLE 26

### Mixture of Equal Parts Each of Dyes of the Formulae

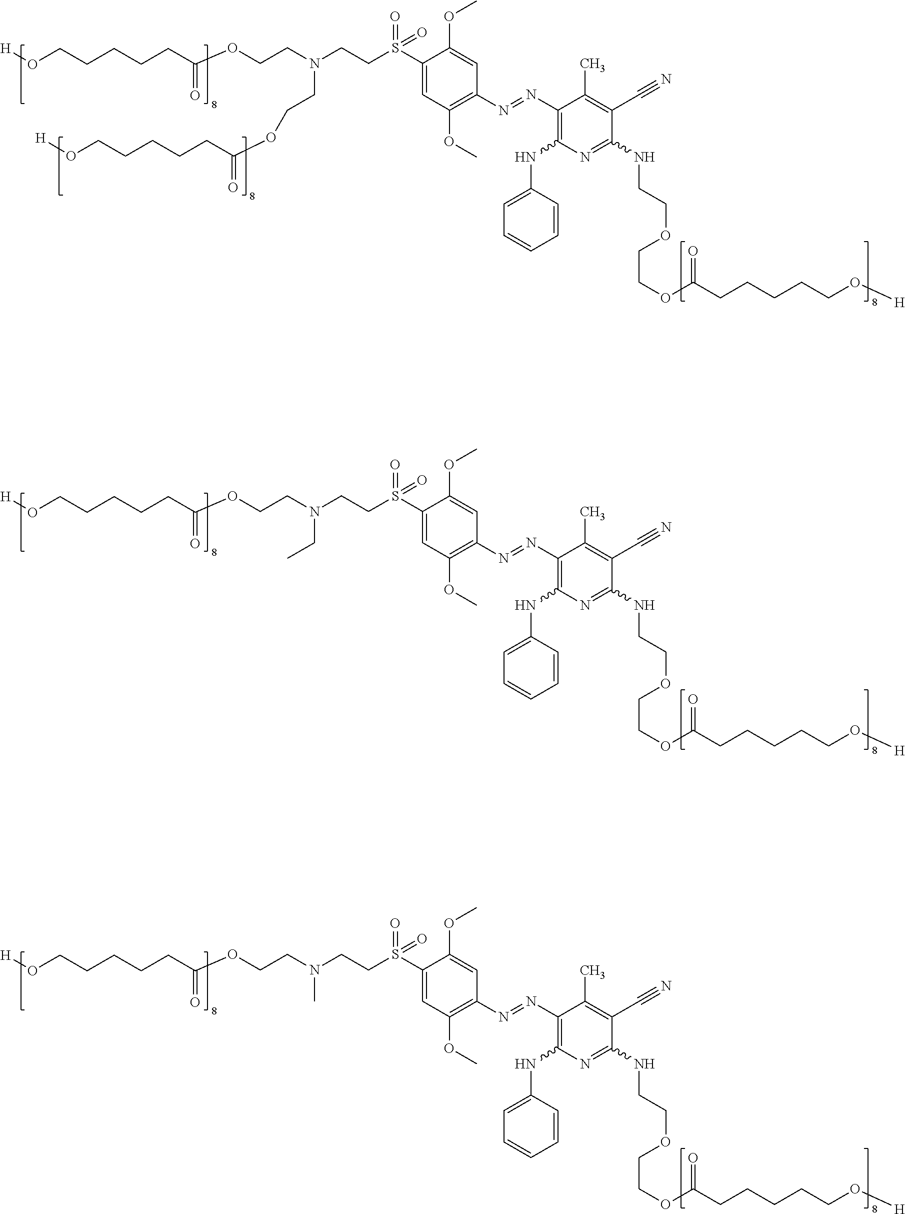

### EXAMPLE 27

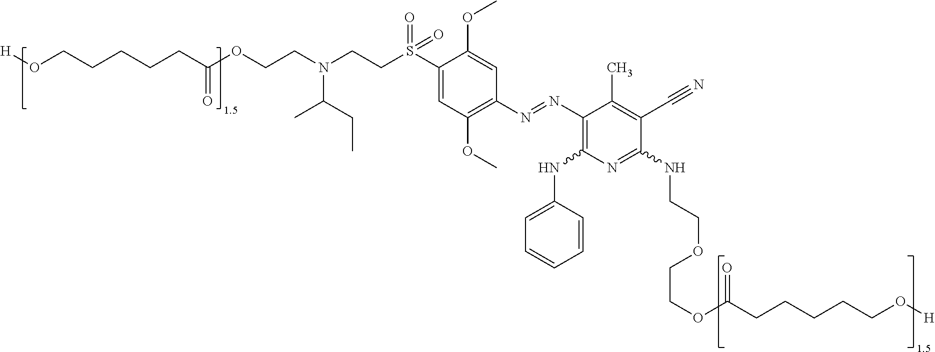

### EXAMPLE 28

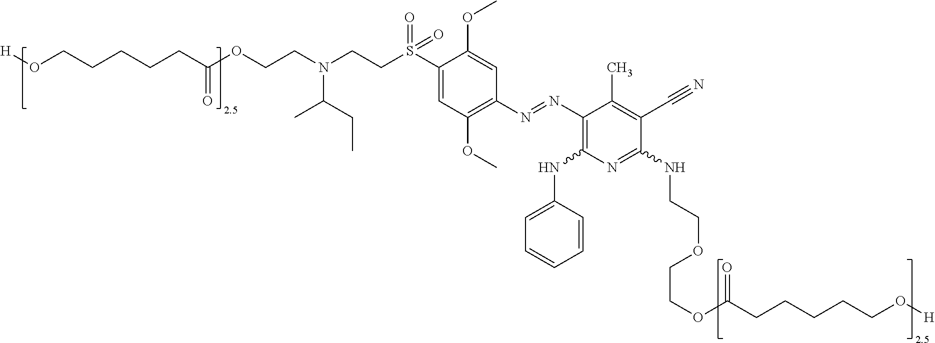

### EXAMPLE 29

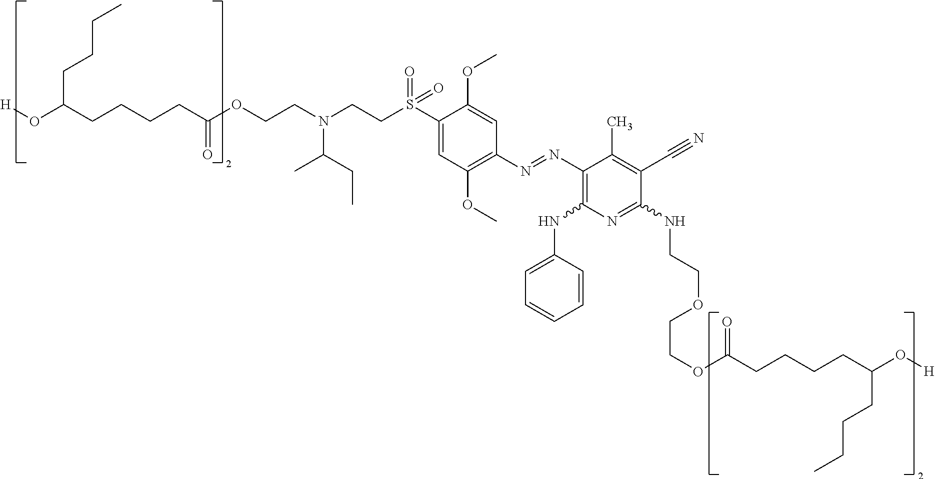

### EXAMPLE 30

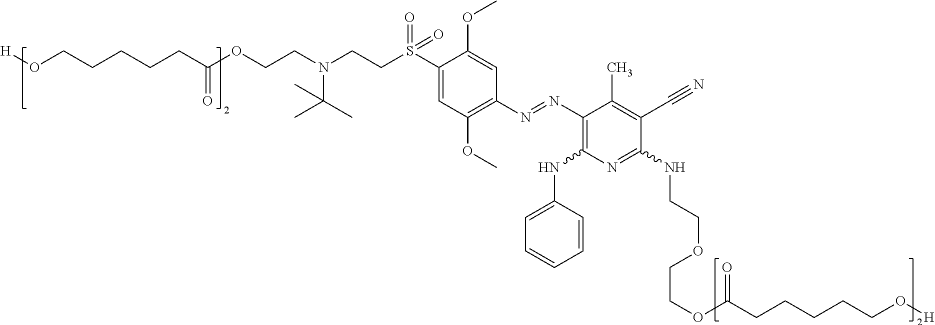

### EXAMPLE 31

1 g of the dye of Example 16 is comminuted in a mortar and added to altogether 2 kg of polypropylene pellet of the Moplen RP348R brand from Basell. This mixture is marled on a roller mill for homogenization and then extruded and pelletized in a ZSE 18HP-D40 twin-screw extruder from Leistritz. The pellet obtained can be processed in a 420 C 1000-100 injection-molding machine from Arburg to form transparent orange sample plaques. The dye has good bleed fastness according to prEN14469-4 and a high resistance to heat according to EN1212877-2.

### EXAMPLE 32

1 g of the heated, molten dye of Example 15 was dissolved in 5 g of hot PEG 400 and added to altogether 2 kg of polypropylene pellet of the Moplen RP348R brand from Basell.

This mixture was mulled on a roller mill for homogenization and then extruded and pelletized in a ZSE 18HP-D40 twin-screw extruder from Leistritz. The pellet obtained can be processed in a 420 C 1000-100 injection-molding machine from Arburg to form transparent orange sample plaques. The dye has good bleed fastness according to prEN14469-4 and a high resistance to heat according to EN1212877-2.

Similarly, the dyes of Examples 12 to 14 were used for coloring polypropylene and the transparent orange sample plaques obtained were measured for their respective bleed fastness, reported in the table which follows.

| | Example | | | | | |
|---|---|---|---|---|---|---|
| | 34 | 35 | 36 | 37 | 38 | 40 |
| Dye of | 12 | 13 | 14 | 15 | 16 | Compound (2f) for comparison |
| example | | | | | | |
| Bleed fastness | 3-4 | 4 | 4 | 4-5 | 4-5 | 2-3 |

The dyes of Examples 1 to 8 and the dyes of Examples 17 to 30 can be used similarly to Examples 31 to 38.

1.-10. (canceled)

11. A dye of formula (1) 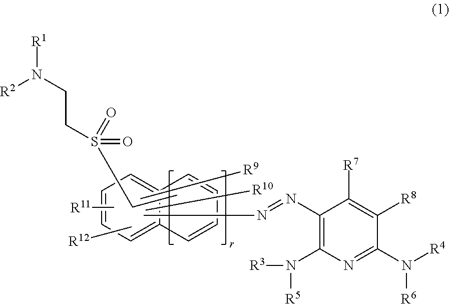
wherein
R¹ is aryl or (C₁-C₆₀)-alkyl which is optionally substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —COOR¹⁴, —CONR¹⁵R¹⁶ or cyano and in the case of (C₁-C₆₀)-alkyl may be interrupted by arylene, —O—, —CO—, —COO—, —CONH—, —SO₂— or —NR¹³—;
R², R³, R⁴, R⁵ and R⁶ independently are hydrogen or have one of the meanings of R¹;
R⁷ is hydrogen or (C₁-C₄)-alkyl;
R⁸ is cyano, carbamoyl or sulfomethyl;
R⁹ to R¹² independently are hydrogen, have one of the meanings of R¹ or are hydroxyl, (C₁-C₄)-alkoxy, hydroxy-(C₁-C₄₀)alkyl, (C₂-C₄₀)-alkylene, halogen, —NHSO₂—, —COOR¹⁴, —CONR¹⁵R¹⁶ or cyano; or
any two of the R⁹ to R¹² radicals which are ortho to each other combine with the carbon atoms to which they are attached to form a 5- or 6-membered ring which is optionally substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —NHSO₂—, —COOR¹⁴, —CONR¹⁵R¹⁶ or cyano;
R¹³ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁴ is aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁵ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁶ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
r is 0 or 1; and
R¹ and at least one of the R² to R¹² radicals each contain at least one group of the formula (OE1) 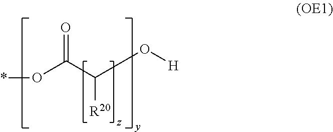
where
R²⁰ is hydrogen, aryl, (C₁-C₄)-alkoxy, hydroxy-(C₁-C₄)-alkyl, (C₁-C₁₀)-alkyl or (C₁-C₁₀)-alkyl interrupted by arylene, —O—, —CO—, —COO—, —CONH— or —SO₂—, where R²⁰, z and y may have different meanings within any one molecule;
z is an integer from 1 to 10; and
y is a number from 0.1 to 60.

12. The dye as claimed in claim 11 conforming to the formula (1a) 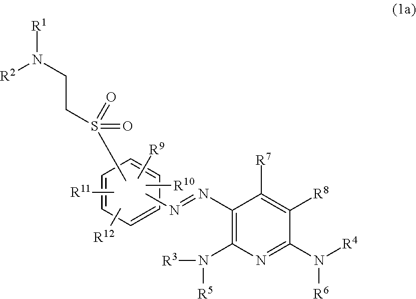
where R¹ to R¹² are each as defined in claim 11.

13. The dye as claimed in claim 11 conforming to the formula (1b) 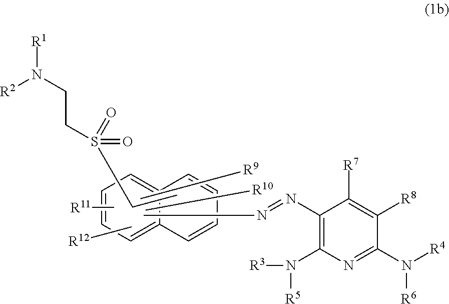
where R¹ to R¹² are each as defined in claim 11.

14. The dye as claimed in claim 11, wherein
R³ and R⁴ are each hydrogen;
R⁷ is methyl;
R⁸ is cyano;
R⁵ and R⁶ independently are phenyl, (C₁-C₄)-alkyl or (C₁-C₄)-alkyl interrupted by —O—;
R⁹ to R¹² independently are hydrogen, (C₁-C₄)-alkyl or (C₁-C₄)-alkoxy;
R¹ and R² independently are (C₁-C₄)-alkyl;
R²⁰ is hydrogen;
z is a number from 1 to 10; and
y is a number from 0.1 to 10; and
where the radicals of the formulae (OE1) are attached to R² and/or R⁴ and/or R⁵ as well as to R¹.

15. The dye as claimed in claim 12, wherein
R³ and R⁴ are each hydrogen;
R⁷ is methyl;
R⁸ is cyano;
R⁵ and R⁶ independently are phenyl, (C₁-C₄)-alkyl or (C₁-C₄)-alkyl interrupted by —O—;
R⁹ to R¹² independently are hydrogen, (C₁-C₄)-alkyl or (C₁-C₄)-alkoxy;
R¹ and R² independently are (C₁-C₄)-alkyl;
R²⁰ is hydrogen;
z is a number from 1 to 10; and
y is a number from 0.1 to 10; and
where the radicals of the formulae (OE1) are attached to R² and/or R⁴ and/or R⁵ as well as to R¹.

16. The dye as claimed in claim 13, wherein
R³ and R⁴ are each hydrogen;
R⁷ is methyl;
R⁸ is cyano;
R⁵ and R⁶ independently are phenyl, (C₁-C₄)-alkyl or (C₁-C₄)-alkyl interrupted by —O—;
R⁹ to R¹² independently are hydrogen, (C₁-C₄)-alkyl or (C₁-C₄)-alkoxy;
R¹ and R² independently are (C₁-C₄)-alkyl;
R²⁰ is hydrogen;
z is a number from 1 to 10; and
y is a number from 0.1 to 10; and
where the radicals of the formulae (OE1) are attached to R² and/or R⁴ and/or R⁵ as well as to R¹.

17. The dye as claimed in claim 11 conforming to the formula (1c) 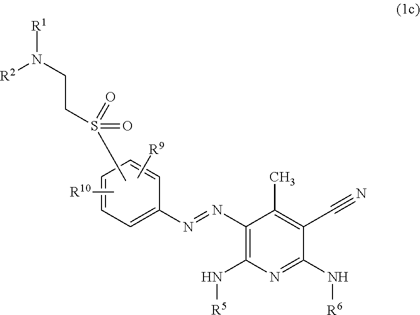
where R¹, R², R⁵, R⁶, R⁹ and R¹⁰ are each as defined in claim 11 and where the radicals of the formulae (EO1) are attached to R¹ and R⁵ or to R¹ and R⁶ or to R¹, R² and R⁵ or to R¹, R² and R⁶ or to R¹, R⁵ and R⁶ or to R¹, R², R⁵ and R⁶.

18. The dye as claimed in claim 17, wherein
R⁵ and R⁶ independently are phenyl, (C₁-C₄)-alkyl or (C₁-C₄)-alkyl interrupted by —O—;
R⁹ and R¹⁰ independently are hydrogen, (C₁-C₄)-alkyl or (C₁-C₄)-alkoxy;
R¹ and R² independently are (C₁-C₄)-alkyl;
R²⁰ is hydrogen;
z is a number from 1 to 10; and
y is a number from 0.1 to 10.

19. A process for preparing the dye of formula (1) as claimed in claim 11, which comprises reacting a compound of formula (2) 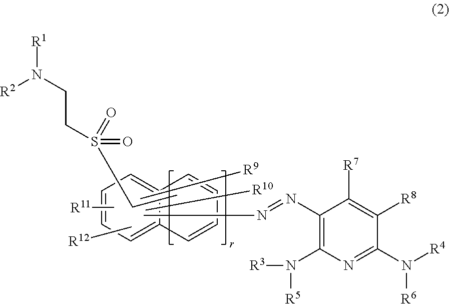
where
R¹ is aryl or (C₁-C₆₀)-alkyl which is optionally substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —COOR¹⁴, —CONR¹⁵R¹⁶ or cyano and in the case of (C₁-C₆₀)-alkyl may be interrupted by arylene, —O—, —CO—, —COO—, —CONH—, —SO₂— or —NR¹³—;
R², R³, R⁴, R⁵ and R⁶ independently are hydrogen or have one of the meanings of R¹;
R⁷ is hydrogen or (C₁-C₄)-alkyl;
R⁸ is cyano, carbamoyl or sulfomethyl;
R⁹ to R¹² independently are hydrogen, have one of the meanings of R¹ or are hydroxyl, (C₁-C₄)-alkoxy, hydroxy-(C₁-C₄₀)alkyl, (C₂-C₄₀)-alkylene, halogen, —NHSO₂—, —COOR¹⁴, —CONR¹⁵R¹⁶ or cyano; or
any two of the R⁹ to R¹² radicals which are ortho to each other combine with the carbon atoms to which they are attached to form a 5- or 6-membered ring which is optionally substituted by hydroxyl, (C₁-C₄)-alkoxy, hydroxy-(C₁-C₄₀)-alkyl, (C₁-C₄₀)-alkyl, aryl, (C₂-C₄₀)-alkylene, halogen, —NHSO₂—, —COOR¹⁴, —CONR¹⁵R¹⁶ or cyano;
R¹³ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁴ is aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁵ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
R¹⁶ is hydrogen, aryl, hydroxy-(C₁-C₄)-alkyl, (C₁-C₄)-alkyl or (C₁-C₄)-alkyl interrupted by arylene, —O—, —CO—, —COO—, —CONH— or —SO₂—;
r is 0 or 1; and
R¹ and at least one of the R² to R¹² radicals each have at least one hydroxyl group, with at least one compound of formula (3a) 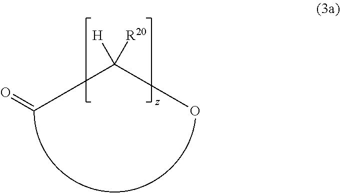
wherein
R²⁰ is hydrogen, aryl, (C₁-C₄)-alkoxy, hydroxy-(C₁-C₄)-alkyl, (C₁-C₁₀)-alkyl or (C₁-C₁₀)-alkyl interrupted by arylene, —O—, —CO—, —COO—, —CONH— or —SO₂—, where R²⁰, z may have different meanings within any one molecule;
z is an integer from 1 to 10.

20. A dye mixture comprising more than one dye of formula (1) as claimed in claim 11.

21. A process for coloring a polymer which comprises adding the dye of formula (1) as claimed in claim 11 to the polymer.

22. The process as claimed in claim 21, wherein said polymer is a polyurethane or a polyolefin.

23. A colored polymer which comprises a polymer and the dye as claimed in claim 11.
